(19) United States
(12) Patent Application Publication
(10) Pub. No.: US 2005/0149538 A1
(43) Pub. Date: Jul. 7, 2005

(54) Systems and methods for creating and publishing relational data bases

(76) Inventors: Sadanand Singh, La Jolla, CA (US); Richard K. Belew, Cardiff, CA (US); Brian T. Bartell, San Diego, CA (US); Marie M. Linvill, San Diego, CA (US); Samir S. Singh, La Jolla, CA (US); James S. Rhodes, La Jolla, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 10/994,189

(22) Filed: Nov. 19, 2004

Related U.S. Application Data
(60) Provisional application No. 60/524,116, filed on Nov. 20, 2003.

(51) Int. Cl. G06F 7/00

(52) U.S. Cl. 707/100

(57) ABSTRACT

A searchable electronic database system that can return search results independent of reference source type. The electronic database system includes information that can be content or discipline specific. The database can be focused to allow research to be limited to the discipline specific universe of information. The database can include person, organization, publication, and other entity types. The publications can include journal articles, books, dissertations, grants, clinical trials, and web resources. The database can also include ontology and lexicon entities. The entities are interconnected through relationships. Searches performed on the database return results across all entity types. A single search can return results from each of the different publication types. Details of the results can be displayed. Dynamic links to one or more fields in a particular result detail can link to a result categorized according to the field.

### RELATED APPLICATIONS

This application claims the benefit of U.S. Provisional Application No. 60/524,116 filed Mar. 20, 2003 which is hereby incorporated by reference.

### BACKGROUND OF THE INVENTION

1. Field of the Invention

The invention relates to the field of electronic databases. More particularly, the invention relates to a searchable, navigatable, or publishable database that produces results that can allow for discipline-specific searching which can be transparent to a type of reference source and can allow for navigation to, from, or between database elements.

2. Description of the Related Art

Researchers often access various electronic databases to search for and uncover information related to a particular subject of interest. However, results that are obtained from standard database searches are often simultaneously over inclusive and under inclusive. The results are over inclusive because they combine results across every discipline, and may return many search results that are completely unrelated or only tangentially related to the subject of interest. For example, a search on the term “induction” may return results relating to mathematics, electronics, electric motors, engine air intake, and other categories. Additionally, the search results may not access the most relevant information sources. For example, a search of an Internet web resource database may not sufficiently search journal articles. Additionally, a search of a journal article database will likely not reveal any results identifying book or dissertation sources. Thus, a researcher must perform the same search in many databases in order to reveal results from a variety of information sources. Additionally, the researcher must constantly manually filter the results to eliminate unfocused search results.

Manual filtering of search results by a researcher and duplicate searching of multiple source databases greatly reduces the effectiveness of a search. Filtering unfocused search results is a constant drain on researcher productivity. Additionally, the need to duplicate a search across numerous databases greatly diminishes the ability to cross reference and further analyze the search results.

Moreover, because the choice of search terms can greatly affect the quality of the results obtained, a researcher that is unfamiliar with key terms or vocabulary associated with a particular field may fail to uncover the most relevant information in a database.

A researcher needs a focused electronic database that eliminates unfocused information while allowing research across a variety of information source types. Searches of the database should provide focused search results. In addition to searching across various information source types, the search should compensate for unfamiliarity with the vocabulary or key terms used in a particular discipline.

Further, research often can be focused or expanded based on information by or about specific people or institutions, such as other researchers or research institutions. As such, the ability to reliably associate information, documents, or information from associated documents with specific people or institutions can be valuable.

Reliance on individuals or institutions to self-describe themselves, their interests, their work, or other information about them can result in inconsistent information with incomplete coverage. Alternatively, reliance on unconfirmed “clusters” of documents without the benefit of a definitive basis for comparison can result in error-full and inconsistent aggregations of information. What is needed is a reliable and scalable means for associating information, documents, or information from documents with people, institutions, or other entities or managing representations of such people, institutions, or other entities in such a way that direct submission and self description is optional rather than mandatory. Further, a system for making these representations available for keyword search, logical navigation, or other useful access is needed.

### SUMMARY OF THE INVENTION

An electronic database system and methods that can return discipline-specific search results independent of reference source type and that can create such a database system are disclosed. The electronic database system can include information that is content or discipline specific. The database can be focused to allow research to be limited to the discipline specific universe of information. The database can include person, organization, and/or publication entities. The publications can include journal articles, books, dissertations, grants, clinical trials, and/or web resources. The database can also include ontology and/or lexicon entities. The entities can be interconnected through relationships. The relationships can include a belief rating based on specific evidence. Searches performed on the database can return results across any or all entity types. A single search can return results from each of the different publication types. Details of the results can be displayed. Dynamic links to one or more fields in a particular result detail can link to a result categorized according to the field. The dynamically linked results can be produced during the initial search or can be produced from the relationships to one or more entities identified in the fields of the dynamic links.

### BRIEF DESCRIPTION OF THE DRAWINGS

The features, objectives, and advantages of the invention will become apparent from the detailed description set forth below when taken in conjunction with the drawings, wherein like parts are identified with like reference numerals throughout.

FIG. 1 is a functional block diagram of a discipline specific electronic database system.

FIGS. 2A-2B are data models of electronic databases.

FIG. 3 is a database entity schema.

FIG. 4 is a data model of an electronic database system.

FIG. 5 is a database relationship schema.

FIG. 6 is a data import management schema.

FIG. 6 is a functional block diagram of a source import system.

FIG. 7 is a functional block diagram of a reference import system

FIG. 8 is a database schema for book import.

FIG. 9 is a flowchart of a book import process.

FIG. 10 is a flowchart of a journal article import process.

FIG. 11 is a flowchart of an organization input process.

FIG. 12 is a flowchart of a web resource input process.

FIG. 13 is a flowchart of a person input process

FIGS. 14A-14B are functional block diagrams of normalization modules.

FIG. 15 is a flowchart of a search process.

FIG. 16 is a flowchart of a search process.

FIG. 17 is a flowchart of a search process.

FIG. 18 is a functional block diagram of a database system.

FIG. 19 is an embodiment of a search input interface.

FIG. 20 is an embodiment of a search results interface.

FIG. 21 is an embodiment of a book expansion interface.

FIG. 22 is an embodiment of a person result interface.

FIG. 23 is an embodiment of a person expansion interface.

FIG. 24 is an embodiment of an article result interface.

FIG. 25 is an embodiment of an article expansion interface.

FIG. 26 is an embodiment of a dissertation result interface.

FIG. 27 is an embodiment of a dissertation expansion interface.

FIG. 28 is an embodiment of a save folder interface.

FIG. 29 is a functional block diagram of shared results system.

FIG. 30 is a flowchart of a result sharing process.

### DETAILED DESCRIPTION OF THE PREFERRED EMBODIMENT

An electronic reference database system and methods are disclosed. An example of the system and methods is described wherein the electronic database may be searched to provide research environment-specific results. The electronic database can be segregated to information specific to a single domain of discourse, community of information, family, or classification. The specific data classification or domain of discourse may include a specific profession or topic. A specific profession may include, but is not limited to, the medical profession. A specific topic may include subareas or specialties within that profession. For example, within the medical profession, an electronic database may be limited to such topics as neurology, communicative disorders, or blood and marrow transplantations. The database system may be segregated in other ways. For example the database may contain information specific to a single entity, such as a university, a system of entities, such as a university system, geographical area, such as a country, or other meaningful grouping. Information stored in the electronic database may be received from various sources. The information stored in the electronic database can describe or pertain to various types of entities, including persons, publications, and/or organizations. The electronic database may be searched by entering a search query. The results of the search query can include various source types and the results are not limited to any one source type. For example, the results of the search may include a list of persons, a list of publications, or a list of organizations related to the search. The electronic database can be internally navigated by dynamic linkages between entities. For example linkages may be followed among representations of a university, schools within that university, departments within those schools, people associated with those departments, and documents authored by or about those people or their work. The electronic database can support linkages and navigation between it and external information sources or databases. For example, navigation may be supported between a person represented in the electronic database and document they authored that is represented in an external database.

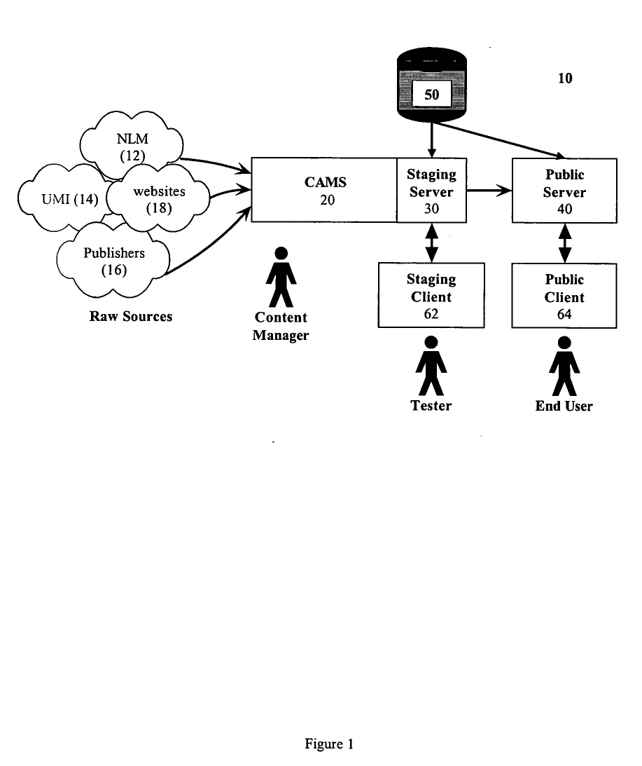

FIG. 1 is a functional block diagram of a discipline-specific electronic database system 10. As will be described below, the overall system can include a collection of such systems or particular subsets of such systems. The electronic database system 10 includes inputs from a variety of raw sources aggregated by a content aggregation management and staging module 20. The content aggregation management and staging module 20 retrieves discipline specific information from the various raw sources and imports it to a database 50. The output of the content aggregation management and staging module 20 is linked to a staging server 30.

The various modules described in FIG. 1 and other functional block diagrams can be performed by one or more computers, processors, or hardware executing software that is stored in one or more readable storage devices. For example, the content aggregation management and staging module 20 can be implemented as software stored in one or more storage devices performed by one or more computers.

The staging server 30 can be accessed by a staging client 62. The staging client 62 facilitates validation and verification of the data stored in the electronic database 50. The staging server 30 and electronic database 50 can in turn be coupled to a public server 40. One or more public clients 64 can access the public server 40 and can access, search, and navigate the results of the electronic database 50.

The raw sources 12, 14, 16, and 18 provided to the electronic database system 10 can be filtered to obtain discipline-specific sources and to ensure high correlations between information content across raw sources, for example to facilitate normalization between imported entities. The raw sources 12, 14, 16, and 18 can include, for example, sources relating to any of the source types such as organizational data, textual data, or person data. In one embodiment, the raw sources 12, 14, 16, and 18 are filtered to obtain information relating to the medical profession. In one embodiment, the information from raw sources 12, 14, 16, and 18 can be filtered to obtain information relating to communicative disorders within the medical profession. The raw sources can include, for example, sources from the National Library of Medicine (NLM) 12, archives from sources such as the UMI Microform and Digital Vault 14, publishers 16, as well as Internet websites 18. The content aggregation management and staging module 20 can filter the information from the raw sources 12, 14, 16, and 18.

Alternatively, a filtering module (not shown) or experts, advisors, or authorities in the identified discipline or subject area may filter the raw sources 12, 14, 16, and 18. For example, a small group of advisors may be commissioned to function as an editorial board with an editor in chief. The advisors may identify additional advisors, experts, or authorities that assist in reviewing and filtering raw sources prior to input in to the discipline specific electronic database 50.

In an alternate embodiment, filtering of raw sources can be implemented on an institution-specific rather than discipline-specific basis.

The information from the raw sources 12, 14, 16, and 18 can be provided in digital format or may be converted into a digital format in the content aggregation management and staging module 20. For example, the content aggregation management and staging module 20 may include a scanner and optical character recognition module (not shown).

The content aggregation management and staging module 20 collects the information from the raw sources 12, 14, 16, and 18 and aggregates the material into the various tables of the electronic database 50. Each of the tables can include attributes describing entities directly included or implied by the information from the raw sources. The attributes can provide properties or characteristics of the entity records. The various entities and attributes are stored in the electronic database 50.

The content aggregation management and staging module 20 is coupled to a staging server 30, which is also connected to the electronic database 50. The staging server 30 can perform content validation and quality assurance of the database information 30. The staging server 30 can perform content validation and quality assurance independently or as part of a quality assurance system.

The staging server 30 can be linked to one or more staging clients 62. Each staging client 62 may in turn be one or more computers, such as personal computers. One or more testers can access each of the staging clients 62. In one embodiment, the testers access the staging server 30 via the staging clients 62 in order to validate and verify the information stored by the content aggregation management and staging module 20 in the database 50. The testers can input one or more queries into the staging client 62 and compare the search results returned by the staging server 30 to expected search results.

In an alternative embodiment, the staging client 62 may be configured to automatically generate a series of queries for which expected results are known. The exact search results need not be known by the staging client 62. Rather, the expected search results only need to be known to a reasonable level of certainty. The staging client 62 inputs the queries to the staging server 30 and compares the search results against the expected results.

In still another embodiment, the staging server 30 can generate verification queries without the need for a staging client 62. The staging server 30 may include a predetermined list of queries and corresponding expected search results. The staging server 30 can execute the queries and compare the results retrieved from the database 50 against the expected results. In this embodiment, the staging server 30 performs content validation, verification, and quality assurance independent of the staging server 62.

The staging server 30 can be in turn coupled to one or more public servers 40. Each public server 40 is also coupled to the electronic database 50. Each public server 40 can store all or some of the content of the database 50. In that way, all or portions of the database 50 can be published to the public servers. The public server 40 can provide access to one or more public clients 64. Each public client 64 can also be a computer such as a personal computer. Alternatively, the public server 40 can provide html mediated access via the internet or public web with one or more of the following access controls for particular subsets of the electronic database: public open access; username and password validation; user IP range validation; referrer IP range validation; institutional intranet controls; or other access controls. In one embodiment, the public server 40 can only access data that has been validated and verified by the staging server 30.

As described in further detail below, one or more end users may access the electronic database through the public client 64. The end user can input a query into the public client 64 and the query can run through the public server 40 to access the electronic database 50. The public client 64 is then provided a list of results, which may be source-type independent.

The electronic database 50 and the public server can include a database stored in an electronic storage system. The electronic database 50 can be configured, for example, using one or more hard disks, RAID disks, optical disks, magnetic media, ROM, RAM flash memory, NV-RAM, and the like, or some other storage.

The database 50 can be configured to store information such that it is accessible by one or more modules, such as the content aggregation management and staging module 20, staging server 30 and public server 40. Alternatively, the database 50 can be configured such that instances within the database 50 are accessible to a subset of modules. In one embodiment, the database 50 is configured to have multiple instances of the same record. For example, a portion of information within the database 50 may only be accessible to the content aggregation management and staging module 20. Another portion of information within the database 50 may be accessible only by the staging server 30. Still another portion of the information within the database 50 may be accessible only by the public server 40.

In an embodiment of a database 50 configuration, the content aggregation management and staging module 20 can access data that includes raw data, data that has been only partially imported, verified data, and validated data. The staging server 30 can access a duplicate instance of data accessible by the content aggregation management and staging module 20. Data records that are ready for validation and verification can be copied into a database 50 portion that is accessible by the staging server 30. Thus, the staging server 30 can access a duplicate instance of a subset of the data accessible by the content aggregation management and staging module 20. Additionally, data that is verified and validated by the staging server 30 can be copied into another database 50 portion that is accessible to the public server 40. Thus, the data that is accessible by the public server 40 can be a duplicate instance of a subset of the data accessible by the staging server 30. Thus, in this embodiment, there may be three instances of the same data record, one that is accessible to the content aggregation management and staging module 20, another that is accessible to the staging server 30, and another that is accessible to the public server 40.

In the following description the following terminology is used. A natural form entity is a singularly identifiable real world entity, for example, a person or a book. A natural form representative is either the natural form entity themselves or an agent acting on their behalf. For example a natural form representative of a person type entity can be the person themselves. A surface form entity is a representation in the database system of a natural form entity which has insufficient information or its information is not deemed sufficiently reliable (or has not yet been verified or checked) to satisfy the criteria of a definitive form. A definitive form entity is a representation in the database system of a natural form entity which meets defined criteria. The criteria are established such that there is a very high confidence level that the definitive form entity has a one to one correspondence with a single natural form entity. The very high confidence level can be set such that an individual looking at the available information within the system would make the same determination. For example, the definitive form entity includes sufficient information to identify with very high confidence the singular associated natural form entity, the record meets a defined level of completeness and the definitive form entity is believed to be unique among definitive form entities within the database (de-duplicated).

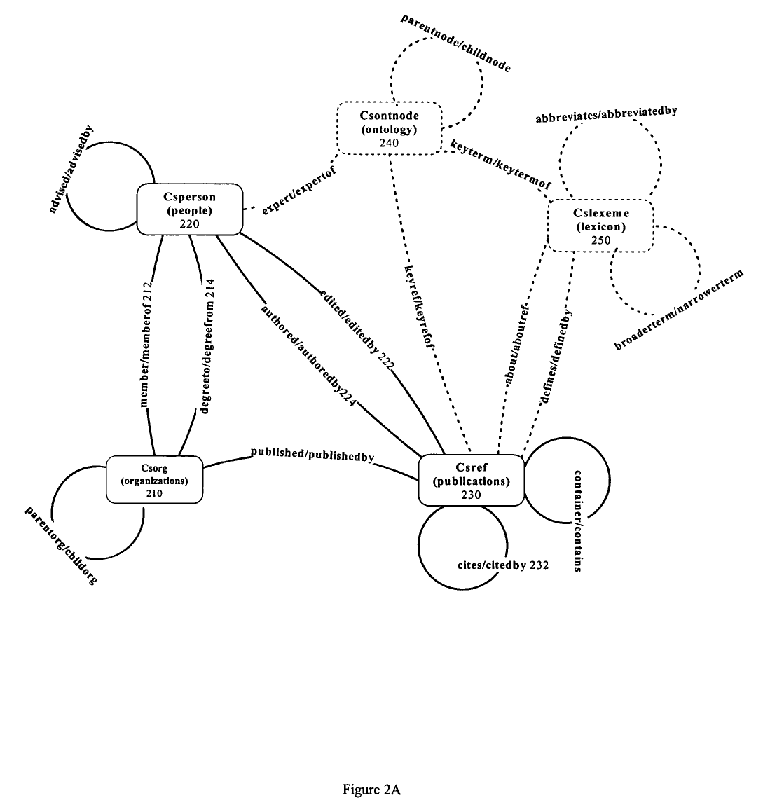

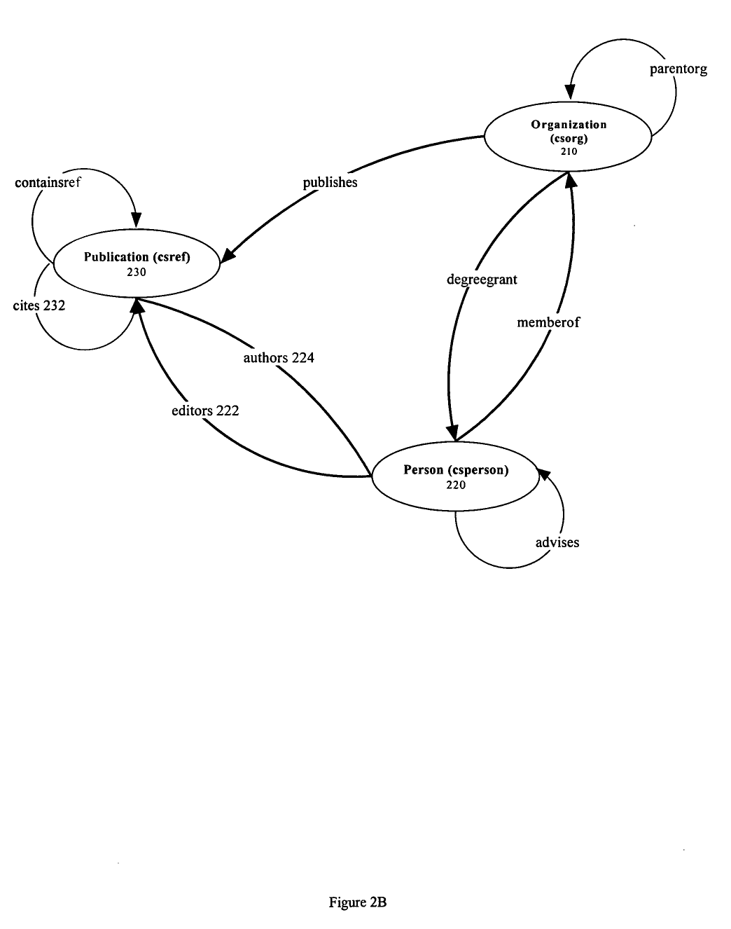

FIG. 2A is a data model of an entity relationship of an electronic database. The data model of the entity relationship can be, for example, a logical model of the database implemented in the electronic database 50 of FIG. 1. The entity data model includes three primary entity types; organization 210, person 220 and publication 230, and can be expanded to include other types, such as tools, equipment, or software tools. Each of the entity types can be definitive form or a surface form. The entity data model may also include ontology 240 and lexicon 250 entity types. Each entity type can be, for example, a table having one or more records identifying organizations relevant to the discipline specific database. Each entity record (or entity) includes attributes that describe or characterize the natural form which the entity represents. For example, a person entity 220 can have attributes such as first name, middle name, and last name.

The organization entity 210 can be, for example, a record of a university, research organization, a hospital, a government agency, a corporation, or a department of a larger organization. The larger organizations having departments or sub-units can be referred to as parent organizations. Additionally, a parent organization may have a plurality of child organizations. Organizations that belong to larger organizations can be referred to as child organizations. Child organizations can be, for example, departments, schools, subsidiaries, centers, divisions, sub-agencies, programs, and the like. A child organization may also be a parent organization. A parent organization such as an academic department, college, or school may have some sub-divisions that grant separate degrees. For example, a school of medicine may have sub-departments that focus on specific medical specialties, such as neurology, pediatrics, and the like. The sub-departments are children of the parent school of medicine. Similarly, the school of medicine is the child of the university. Thus, in this example, the school of medicine is both a parent organization and a child organization.

The entities, 210, 220, 230, 240, and 250 are linked by relationships, for example 222 or 224. The relationships between entities shown in the data model are only examples that are representative of the database, and are not exhaustive representations of all possible relationships in the database. Examples of relationships linking entities include degreeto/degreefrom 214 relationship linking persons 220 with organizations 210 and authored/authored by 224 relationship linking persons 220 with publications 230.

Typically, each relationship is a two-way relationship. The relationships are directional but have a symmetric counterpart. For example, for each person 220 that has the relationship of being a member of an organization, that organization 210 has a relationship of having a member which is the person. The relationships may be between different entity types or may be between different entries within a single entity type. Examples of relationships linking different entity types include member/memberof 212 relationships and degreeto/degreefrom 214 relationships linking organizations 210 to people 220. Other examples of relationships linking different entity types include authored/authoredby 224 relationships and edited/editedby 222 relationships linking persons 220 to publications 230 and describes/described by relationships linking either organizations or people with publications. Example of a relationship linking two entity records within the same entity type includes the cites/citedby 232 relationship linking two different publications within the publication 230 entity type and parent/child or affiliated with/affiliated with relationships linking different organizations within the organization entity type.

The person entity type 220 can include a list of people including, but not limited to, authors, important people in the field, affiliates with certain important institutions, corporate board members, executives, or employees, government officials, or individuals within certain professions, such as doctors, lawyers, or entertainers. Person data can include, for example, the first, middle, and last names corresponding to the person. Person data can also include, for example, a textual statement of research or professional interests, a link to the person's web page, professional tools, techniques, or resources, and the like. The statement of research interests may be analogous to the type of statements typically found on a person's departmental website. Links to Internet pages can be, for example, links to a person's home page or a link to a web page listing a person's publications.

The publications entity type 230 can include whole publications or only parts of publications. The publications may include, but are not limited to, books, chapters, journal articles, dissertations, and grant types. The organization entity type 210 can include academic departments, universities, corporations, research groups, or any other group.

The lexicon entity type 250 can include key terms, phrases, or vocabulary associated with, for example, a discipline-specific database. The lexicon 250 can include, for example, the terms listed in the various indices of publications. For example, some or all of the terms listed in the index of a book can form the basis of a lexicon. The book can be, for example, a book that is a record in the publication entity 230. The aggregation of terms listed in the indices of all of the book records can form the lexicon.

Alternatively, the lexicon may be developed based on counting the number of occurrences of terms in publications. The potential lexicon records may be ranked across multiple publication indices. For example, the potential lexicon records can be compared against terms included in the index of a book. Some words that appear with great frequency may correspond to common words that have no ability to identify discipline-specific subject matter. Other words that appear with lesser frequency may be key to a particular area of interest within the domain of discourse.

The potential lexicon records may then be used as query terms and tested against candidate publications to determine the ability of the record to discriminate meaningful information. Thus, some terms that initially rank high as appearing frequently in the indices of books and number of occurrences may have no ability to discriminate meaningful information. For example, the terms may be too common or may have multiple meanings. Terms that rank high and have the ability to discriminate meaningful information may be included as lexicon 250 records. Lexicon 250 records can be useful in revealing a vocabulary of terms used within a discipline or field. However, lexicon 250 records may not provide a user with an organization of concepts within the database field or discipline.

The ontology entity type 240 can include records of topics arranged in a topic tree. The ontology 240 includes key concepts of the discipline specific database and relates the key concepts in a categorized manner. The ontology 240 records may thus be included in or formed of key terms from the lexicon 250 records.

As was referred to above, a record listed in an entity type table can be listed as either a surface form or a definitive form. A surface form can include data as it looked, literally, when it was imported from an external source. Surface forms may hold incorrect, outdated, or incomplete data, since sources are known to be flawed and/or incomplete. A definitive form entity is the “correct” representation of an entity. A definitive form entity can be based on a combination of one or more surface forms and information sources external to the electronic database. The creation or derivation of a definitive form entity from a corresponding surface form is referred to as “normalization” and may be manually performed, automated, or a combination of manual and automated actions. For example, when deriving or creating a definitive entity form from a surface form, abbreviations may be expanded, data filled in, or some other data manipulation, transformation, processing, or expansion may occur. In one embodiment, surface forms and definitive form records (entities) can be stored in different, but mostly isomorphic, tables. In another embodiment, both surface form and definitive form entities are stored in the same tables. Occasionally, the surface form of the record coincides with the definitive form record. For example, a definitive form record of a person may be their full name using complete first, middle, and last names. Imported data may refer to the person by their complete first, middle, and last names. Thus, the surface from of the person from the imported data matches the definitive form record.

As will be discussed in further detail below, person data records can be imported and/or manually input from one or more add-hoc information sources, such as websites. A surface form record of a person imported from a website can be stored in the same table as the definitive form version of that person. Storing both forms of the record in the same table minimizes the amount of management code, and allows surface forms to act as definitive form entities by flipping a status bit. Where a majority of content will be published without normalization, for example, journal and journal author content, use of the same table for both forms saves a great deal of effort.

A definitive form entity record represents a real world instance of an entity. For example, there should be one and only one definitive form entity in a single discipline specific database for a specific natural form person known as “Dr. Sadanand Singh”. However, if there are multiple natural form people with the name “Dr. Sadanand Singh”, each will correspond with a distinct definitive form entity. A surface form is the literal text that we might see in some book, or in some reference, or on some web page, that describes an entity. For example, the entity Dr. Singh may have published two books and appear on a website. The entity may have three surface forms, and each might be different.

A first book's text may list the person as “Dr. Sadanand Singh”, a second book may list the person as “Sadanand Singh”, and a website may list the person as “Dr. S. Singh”. Furthermore, each surface form name may state a different surface form affiliation. Dr. Singh may have been at different institutions when each book was written, and the implied affiliation on a particular website is that the person is affiliated with the organization represented by that website. Thus, there is an abundance of surface forms from various books, references, and web scraping or harvesting. Additionally, there may be no actual precise information about entities.

The normalization process, then, establishes the correct natural form entity for each surface form, and implements the canonical or standardized statement of each entity's properties, such as name, affiliation, email, etc., and defines such statement as the definitive form representation.

It may be advantageous to create the definitive forms of surface forms in order to determine more accurate relationships between the various entities. For example, it may be difficult to establish a complete relationship of author to publication without generating a definitive form entity of the person corresponding to numerous surface forms of the person. A definitive form of an entity eliminates the creation of numerous partial relationships linking different surface forms that correspond to the same definitive form. Numerous surface form relationships do not provide the information that can be provided by a definitive form relationship. For example, different surface forms of the same person entity may have independent relationships to different organizations. The definitive form entity corresponding to the different surface forms will have the relationships to all of the different organizations. The database can return more complete search results when the definitive form relationships are known.

Typically, the surface form contents of an entity are never updated or changed. If a surface form were updated or changed, the ability to look at the original source record would be lost. Therefore, if a surface form record needs to be changed, a new entity is typically created, and the surface form entity linked to the new updated record in the new entity. The surface form of the original record as well as the surface from of the new entity record can be linked to the same definitive form record.

In one embodiment, each entity and relationships between entities can also include associated meta data. In general, the meta data is used to provide information about the underlying entity. For example, the meta data can include the following types of information:—start and end date of the underlying entity or the date of occurrence of the underlying entity; evidence—the source of the evidence of the existence of the entity or relation between entities and a ranking of the believability of that source, for example on a scale of 0 (not believable) to 100 (undeniable); exposure—can be set to be triggered to make the record or portions of the record not visible in certain circumstances; and notes—explanatory notes. All types of meta data could but would not necessarily be used for all entities. In addition metadata can be used for attributes of entities. For example the attribute of last name of a person entity could have a start and end date when a person's name has changed, for example through marriage. In addition the source of the evidence of that name change could be noted and the believability of that source could be ranked. The exposure field of the metadata is useful when the database is published to different customers or for different uses. For example variations of the database which hide or expose different fields, depending on the service provided to that customer, could be controlled through the exposure field.

FIG. 2B is another embodiment of an entity relationship data model. The embodiment of FIG. 2B includes only the three primary entity types; publication 230, person 220, and organization 210. The data model omits the entity types ontology 240 and lexicon 250 found in the data model of FIG. 2A. The data model of FIG. 2B also shows directional relationships, for example 222, 224, and 232. However, the examples of directional relationships are shown in a single direction solely for the sake of brevity. The relationships typically include a symmetric counterpart as shown in FIG. 2A. Meta data can also be used with this simplified data model as was described above.

The data model shown in FIG. 2B represents a simplified form of the data model shown in FIG. 2A. The simplified data model may be implemented, for example, in disciplines, fields, domains of discourse, organizations, or geographical areas in which a specialized vocabulary is not used. Alternatively, the lexicon and ontology entities may be omitted in databases that are directed towards specialists in the discipline field. There can be other situations in which either the lexicon or ontology entities are omitted from the data model.

FIGS. 2A and 2B represent examples of possible data models for the entities. Other data models, can include additional entities or may omit one or more entities from the data models of FIGS. 2A and 2B. For example, an alternative data model can include a person entity and a publication entity and omit the organization, lexicon, and ontology entities. A database implementation of the data model may put no emphasis on the possible organization relationships but may only be concerned with relationships between people and publications.

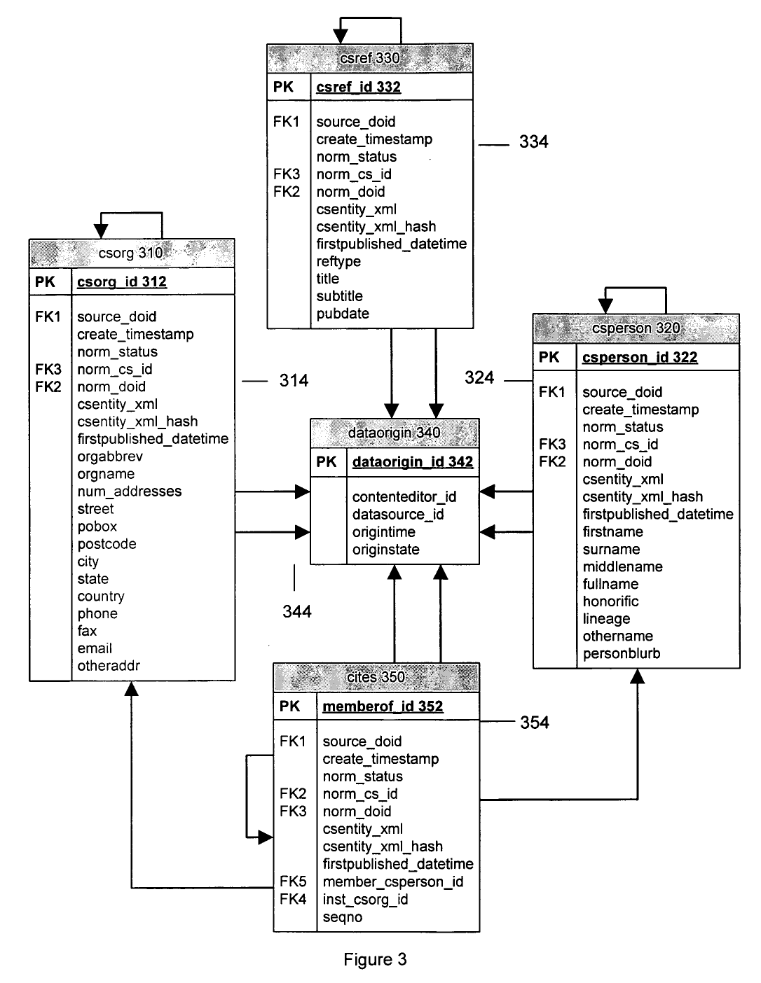

FIG. 3 is an entity schema that is an example of a schema for the data model shown in FIG. 2B. The entity schema includes a number of entity tables corresponding to the entities shown in the data model. One example is provided of a relationship table interrelating two of the entity tables.

Each entity table includes a primary key that uniquely identifies the record in the table. Within each table, there also exist a number of attributes associated with that primary key. The entity ID is a unique integer key which can be, for example, an auto-incrementing sequence number that identifies the primary key.

One or more of the attributes can also be a foreign key. A foreign key is a field in a relational database table that matches the primary key of another table. Thus, an attribute that is a foreign key can also have its own attributes. The foreign key can be used to cross-reference the tables. Each of the primary entity tables includes an entity ID as the primary key in the table.

In addition to the possibility that one or more of the attributes themselves have attributes, the attributes may be structures. For example, an address attribute can have as its structure street, city, state, and country. Alternatively, the elements of the structure can be attributes of the address attribute.

The attributes include standard attributes, which are provided for every entity type. Additionally, entity-specific attributes can be included for particular entity types.

In one embodiment, the standard attributes include an entity ID, a data origin, a time stamp denoting a specific time of creation, a normalization status, a pointer to a normalization instance, a primary representation of the entity, the full entity hash number, and a first published date and time record.

The entity ID is a unique primary integer that identifies the particular entity. The source ID represents the data origin for a record. The data record defines when the source record was initialized and how the record was created. This record never changes once it is created.

The standard attributes included across the different entity tables are also referred to as standard management columns within the table. In the embodiment described above, the management columns are:

entity_id (csorg_id, cspersond_id, csorg_id): The unique primary integer key identifying the record. The primary integer key may be an auto-incrementing sequence number.

source_doid: The data source or origin of the particular record. This value defines the who/how/when of this record's origination. The value is initialized when the record is created, and typically never changes.

create_timestamp: The creation timestamp indicates the specific time the data record was created. This attribute may seem redundant with source_doid, but it's not. A single source_doid may be created for a data input session when a system administrator logs in. Therefore, the granularity of the source_doid value can be fairly large. Many data edits can occur in one session. The timestamp gives a micro-view of when the content is created.

norm_status: The normalization status is indicated by this value. This attribute includes a set of codes that indicate whether the record has just been imported, has been auto-normalized, has been manually verified, or is ready to be published.

norm_cs_id: This attribute provides a pointer to a definitive form instance of the associated record. For example, a person record may be imported from scraping a department's website. This record is a surface form and a corresponding data origin indicates a rawsource. If this record is incomplete or inaccurate, then a new record is created. The new record may be created, for example, by manual effort or by automatically merging different records for the person. The norm_cs_id of the surface form record points to the entity_id of the definitive form record.

norm_doid: When the norm_status or norm_cs_id is updated, the norm_doid records the data origin of that updating work. A history of doid's is typically not required nor is the history maintained.

csentity_xml: The attribute represents the full record for a given entity. For example, the full record for an entity can be stored as XML in an entity document type definition (DTD) element. The full record is the primary representation of the entity. For example, a person entity has an XML description that includes its first name. The first name is stored both in the csentity_xml element and in the table column ‘firstname’. However, the column data is just a reflection of the primary content in the XML—it is represented at the column level to make selections more intuitive and efficient as opposed to mining the XML. However, when content is updated, it is typically updated in the XML and reflected in the column value.

csentity_xml_hash: The full csentity_xml can be big. And we want to perform exact-match lookups on it. Therefore, we store the Java String hash code of the csentity_xml here, so that we can quickly narrow in on one or more matching items. This is because you can't place an index on a text field in MySQL.

firstpublished_datetime: This attribute indicates the date and time that the associated record was first published to the runtime system. If this field is null, then the record has not yet been published. A system administrator may have more freedom to delete, split, or merge unpublished record. If this field is null, then we need to preserve this record's identity, because an administrator may be referring to its ID in some saved state, such as in an electronic bookshelf.

For a given entity in the database, it is easy to know whether it is a surface form, and separately to know the normalization status of the entity. An entity is a surface form if its DataOrigin refers to a DataSource that is_rawsource. A surface form can also be accepted for publication, meaning, its content is valid and will be presented to the user. Every entity has a status flag (norm_status, an integer) which indicates whether the given data has been accepted for publication.

FIG. 3 shows table definitions for the three primary entity tables, organization 310, person 320, and publication 330. Also depicted are their dependencies on the DataOrigin table 340. In addition, an example of one relation table (memberof) is also depicted. The relationship table is shown here to illustrate that the management columns in a relation table can be the same as the management columns in the entity tables.

As noted earlier in the description of the full record, the entity-specific columns exist in the tables to make querying more efficient and obvious. These column values are merely reflections of the fundamental data stored in the full record for each entity, for example the entity XML DTD. The full record usually contains more information than what is reflected in the columns. If an entity's data changes, then the full record is typically updated and the updated values reflected to the table columns.

The entity schema includes an organization table 310. An organization identifier 312 is the primary key for the organization table 310. The organization identifier 312 identifies individual records within the organization table 310. Organization attributes 314 can include the name of the organization, one or more abbreviated names of the organization, addresses, degrees granted, publications published by the organization, and the like, or some other attributes. Some of the attributes, such as degrees granted will only contain data that is relevant to the specific discipline. For example, a medical-based database may only be concerned with medical degrees and medical specialty degrees conferred by a university.

Similarly, a person table 320 is used to catalog people in the database. A person identifier 322 is the primary key for the person table 320 and is used to identify each record of a person stored within the database. Person attributes 324 can include, for example, first name, surname, and middle name. Other attributes within the person table 320 can include, for example, honorific, lineage, home page, and the like, or some other attributes. The honorific attribute can identify the title, such as “Dr.” or “Sir” associated with the entity. The lineage attribute can identify whether the person is known as “Jr.” or some other lineage designation. Other attributes provide other related information.

A reference table 330 is used to catalog the publications stored in the database. A reference identifier 332 is the primary key for the reference table 330 and is used to identify each record of a publication stored within the database.

The entity schema shown in FIG. 3 also includes a data origin table 340. The data origin table 340 shows the identity of the person entering the data, for manual data entry, or the origin of the data, for automated data import. The identity of the person or data source is stored as a data origin identifier 342. The data origin identifier 342 is the primary key for the data origin table 340.

Additionally, a relationship example is provided in between the organization and the person tables. The memberof relationship linking the organization and person tables is provided only as an example. A relation such as “membership” or “memberof” can indicate historical affiliations that are known for the person. The affiliations may be a subset of all true historical affiliations. The affiliations can also be, for example, labeled as current to distinguish contemporary affiliations from historical affiliations. Moreover, meta data can be used to describe the time periods during which each affiliation was current. As will be seen below, there are additional number of relational tables that may exist linking the various entities.

FIG. 3 also includes a representation of meta data 325. Meta data can be associated with any entity and with any attribute of any entity.

In addition when the database system includes more than one discipline specific data base, it can be useful to have a global unique identifier assigned to entities that exist in more than one of the discipline specific databases. Therefore, if searching is conducted across more than one of the data bases, duplication of results can be detected. Further, each discipline-specific database may have discipline-specific representations of entities, even if those entities occur in more then one such database. For example, the representation of a person in a database specific to cancer may include only cancer-specific publications authored by that person and cancer-specific organizations to which the person is a member; meanwhile, the same person may be represented within a neuroscience-specific database that only includes neuroscience-specific publications and organizations. In this case, there may be some customers, purposes, or service levels for which both cancer-specific and neuroscience-specific publication & organization sets may be relevant and published for access using the global unique identifier to detect duplication and aggregate information. Simultaneously, for other customers, purposes, or service levels, only the discipline-specific information may be relevant and published for access.

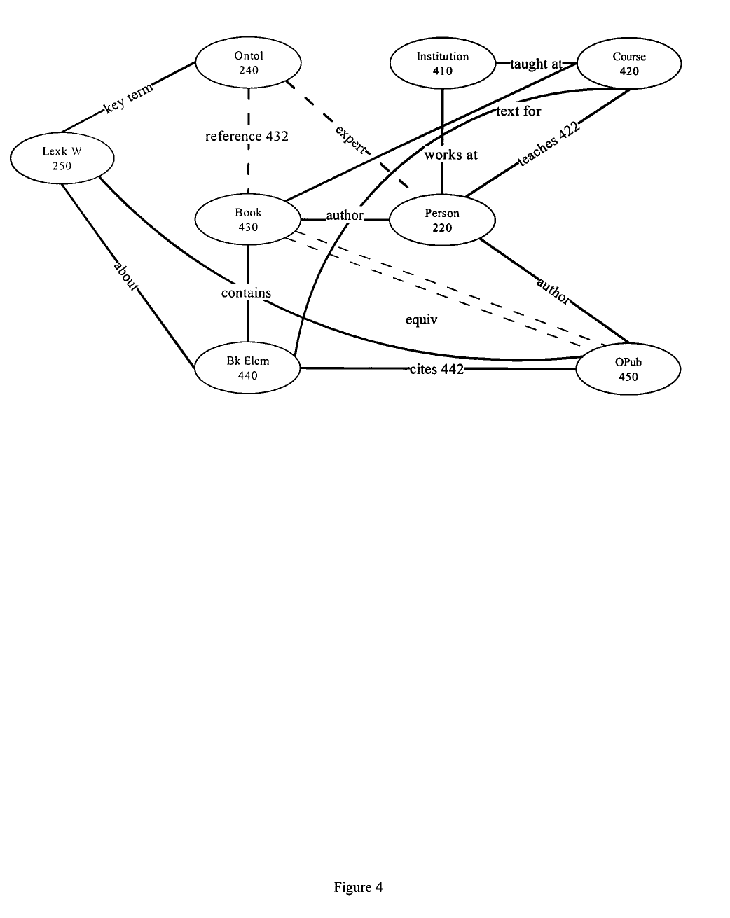

FIG. 4 is an alternative embodiment of an entity data model. The entity data model of FIG. 4 is particularly targeted towards relating information from academic institutions. The entities in the data model include a person 220, ontology 240, and lexicon 250 as in the data model of FIG. 3. Additionally, the data model includes entities that are institutions 410, courses 420, books 430, book elements 440, and other publications 450.

Examples of relationships linking the various entities are provided in FIG. 4. For example, the reference relationship 432 links the book 430 and ontology 240 entities. Additional examples include the cites relationship 442 linking the book element 440 and other publication 450 entities.

The entities shown in the data model of FIG. 4 have analogs in the data model shown in FIG. 2A. However, there are some entities in the data model of FIG. 4 that do not appear in the data model of FIG. 2A. For example, the course entity 420 shown in FIG. 4 does not appear in the data model of FIG. 2A and is not represented in any of the entities of FIG. 2A. Thus, the data model may be structured differently for different discipline specific databases, customers, purposes, or service levels. The data model can be tailored to capture entities, such as courses 420, that are more prominent in particular disciplines.

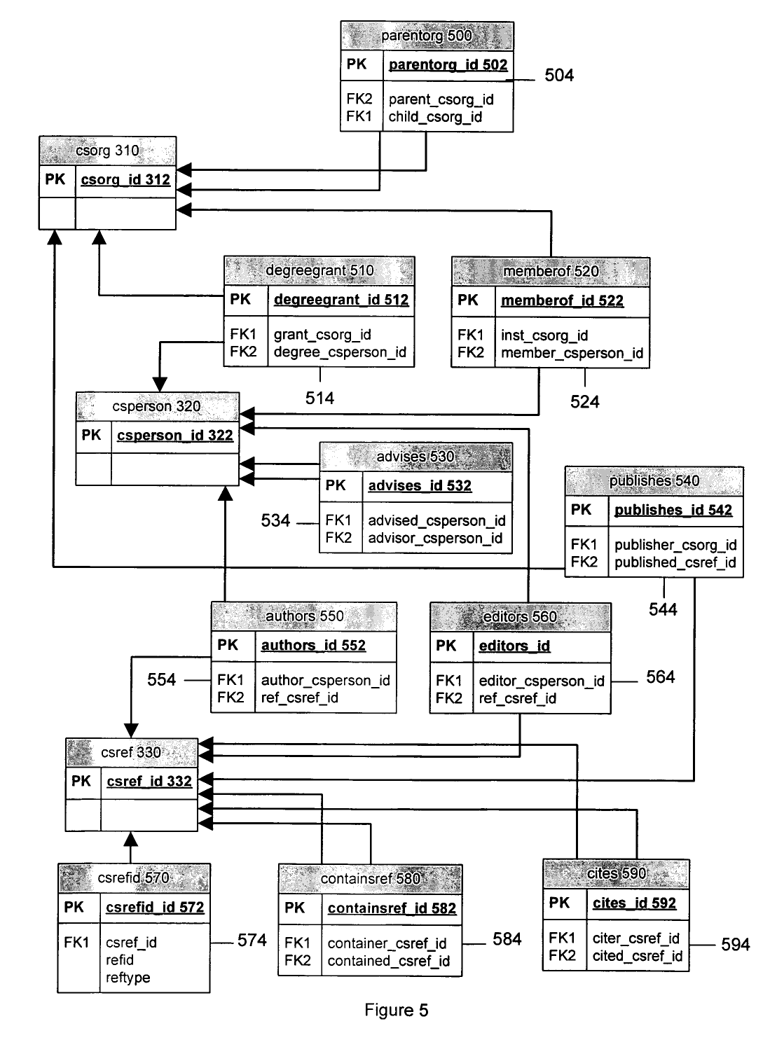

FIG. 5 is a relationship schema. The relationship schema of FIG. 5 shows the tables that link the various entities of FIG. 2B. The entity tables, organization 310, person 320, and reference 330 are only shown with their primary keys and are not shown with their attributes. Additionally, the metadata that can be associated with each entity and attribute are not shown.

The relationships can also include attributes that describe or characterize the relationship. For example, the memberof relationship 520 can describe the relationship between a person 320 and an organization 310. The memberof relationship can include the “role” attribute that describes the role the person 320 (that is the member) plays in an organization 310. For example, possible values for the “role” attribute include “professor” or “lecturer.”

Each of the relationship tables includes a primary key that uniquely identifies the records stored in the table. Additionally, each of the tables may include one or more foreign keys that match the primary keys of another relationship table or of an entity table. The foreign keys can be one or more attributes associated with the relationship. For example, the degree grant relationship includes a degree grant ID as the primary key. Additionally, the degree grant relationship includes a grant organization ID as a foreign key and a degree person identifier as a foreign key. The degree granting organization and the degree receiving person are referred to by the degree grant relationship. FIG. 5 shows a relationship schema that can be implemented in the majority of discipline specific databases. Some databases having entity data models different from those shown in FIGS. 2A-2B can include additional relationships or can omit some relationships.

Some relationships are primarily related to organizations. A parent organization relationship table 500 includes a parent organization identifier 502 as the primary key identifying the record. The foreign keys 504 identify the relationships to other organizations. For example, one of the foreign keys can identify the organization identifier of a parent organization, if any. Similarly, a different foreign key can identify the organization identifier of a child organization, if any.

Other relationships are more directed towards defining the relationships between various people or between people and organizations. A degree grant relationship table 510 identifies degrees granted. Foreign keys 514 identify degree granting organizations and persons to whom the degree is granted. Similarly, a member relationship table 520 includes a member identifier 522 as a primary key of the table. Foreign keys 524 identify the organization identifier and person associated with the organization. An advisor relationship table 530 has an advisor identifier 532 as the primary key. Foreign keys 534 identify a person that serves as the advisor and a person that was advised.

Still other relationship tables identify the relationships between people and publications. Author and editor relationship tables, 550 and 560 respectively, identify publications authors and editors. The author relationship table 550 includes foreign keys 554 that identify the publication and the person authoring the publication. Similarly, the editor relationship table 560 includes foreign keys 564 that identify the publication and the person editing the publication.

Other relationship tables identify relationships between publications. The container relationship table 580 includes foreign keys 580 that identify the container reference and the identity of the reference contained in the container reference. Similarly, the citation relationship table 590 includes foreign keys 594 that identify the citing reference and the reference cited in the citing reference.

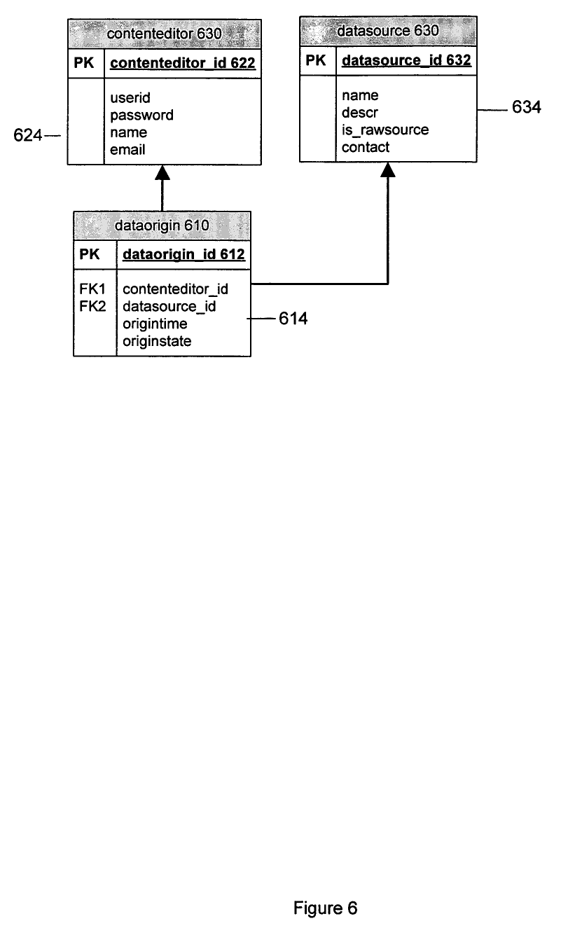

In order to generate the database, raw data must be aggregated and parsed into the various tables of the database. FIG. 6 is a representation of a content aggregation and management schema. The schema includes three entities: content editor 620, data origin 610 and data source 630. The data source table 630 represents the raw source from which the data is retrieved. For example, the data source may be a journal article, a book, or a repository of journal articles or books. The data origin table 610 includes a time stamp and an origination date to indicate a time of data origination. Thus, the data origin represents the time that the raw data source was imported into the database. The content editor table 620 identifies the system administrators that may edit content stored within the database. The content editor may be identified with editing sessions in order to provide an update history.

As we stated earlier, the logical data model can have a number of different implementations or realizations. Different software implementations include extensible markup language (XML), Java architecture for XML binding (Jaxb), and Java XML integration (Jdom). The different implementations can all reflect the same underlying data model. The implementations can be interchangeable. There may be reasons that one implementation is preferred over another.

XML is one possible implementation. XML is an exportable and importable text-based representation of the data model. An XML implementation may be preferable when importing data from third parties, and when transmitting content between major sub-systems. For example, when a server delivers a detailed representation of an entity to a client at runtime, it can send XML. Also, XML text can be stored in a database when an entity is persisted because XML is language neutral.

JDom is another possible implementation. It is a convenient in-memory representation of XML for a Java program. Attributes and child elements can be accessed by name in a flexible way. It can be easy to create and manipulate XML in-memory using JDom, but, it can also be easy to create XML that does not conform to a given document type definition (DTD). A JDom implementation can be advantageous for cycling through all attributes or relations on a given object without caring much about DTD-conformance or perhaps the specific meanings (types) of the attributes and relations. For example, a content editor explorer entity view can use a JDom implementation to simply display in HTML all attributes and relations on a given entity. Convenient methods for translating back and forth between XML text and JDom representations are available.

Jaxb is perhaps the least obvious implementation, but perhaps the most powerful. A Java class file can be created for every element in a DTD. A Jaxb implementation allows type-safe getters and setters to construct and access XML content in-memory. XML text can be read from and written to in-memory Jaxb classes in a way that is guaranteed to be syntactically correct with respect to the DTD. For example, the Jaxb pre-compiler creates a java class that includes methods getFirstname( ) and setFirstname( ). A Jaxb implementation may be preferred when needing to create DTD-conformant XML, or for type-safe compile checking. Jaxb is the default representation of an entity when interfacing with the database. Jaxb objects can be converted to and from both XML text and JDom using conversion utilities.

A recent enhancement to the Jaxb model is the declarative statement of attributes and relations, which allow the developer to get and set attributes and relations in Jaxb in a type-safe way, but using flexible naming analogous to JDom. This capability was added to handle general purpose entity editing, but may be useful in other contexts as well (for example, merging data). When using declarative attributes and relations, a logical data model can change with no changes required to the editor.

Thus, the logical data models can be implemented in one or more ways using one or more modules. The modules can be, for example, hardware modules, software modules, or a combination of hardware and software modules. Where a module is implemented as a software module, the software may be stored on one or more storage devices, and executed in one or more computers or processing devices. Each of the implementations detailed in the following figures can thus be implemented in hardware, software, or a combination of hardware and software.

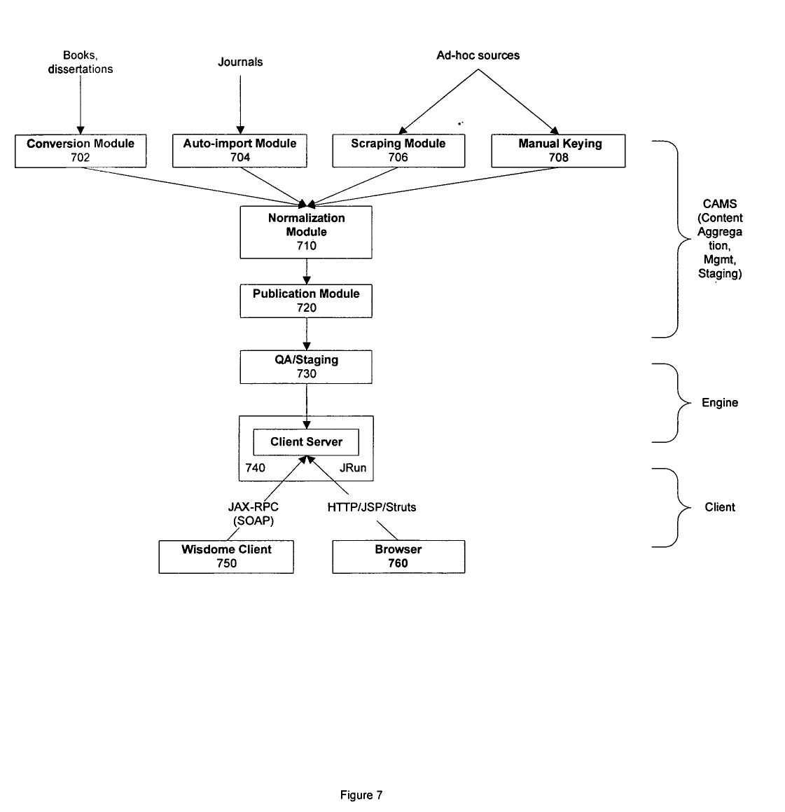

FIG. 7 is a functional block diagram of the source transparent database system. Information from raw sources such as books, dissertations, journals and ad hoc sources are aggregated, imported, and supplied to a search engine which then supplies the data to a client. Raw data must first be aggregated, parsed into the database and staged in a quality assurance staging server prior to being supplied to a client server.

As previously discussed, the database can be configured to include discipline-specific information. A discipline-specific database enables a user to obtain results that are focused on the discipline or domain of discourse that is of interest.

In order to generate a discipline-specific database, the information that can be imported into the database must be filtered to eliminate non-relevant sources. The filtering operation can be performed in the import module for the particular type of raw data. Thus, each of the import modules 702, 704, 706, and 708 can include a filtering operation or filtering module.

In one embodiment, a filtering module can be automatic text classification (ATC) software implemented in one or more computers, hardware, or devices capable of executing the software. ATC software can use predetermined example articles, such as journal articles, books, grants, or dissertations that are known to be related to the desired profession or discipline. The predetermined example articles are used by the ATC software to create a model of terminology used in information sources related to the field. The ATC software estimates whether a given information source, such as a journal article, book, grant, or dissertation is likely to be related to the discipline. For example, the ATC software can determine a likelihood based in part on a comparison of a list of key terms or a ranking of key terms against a predetermined threshold. If the ATC software determines that the likelihood is higher than a predetermined likelihood threshold, the article is filtered into the database, or is otherwise selected for inclusion into the database.

The manner in which raw sources are imported into the database depends on the type of the raw data source. Books are one of the raw data source types and can be converted using the conversion module 702. Books typically include a table of contents, bibliography, index and body content in addition to summary data such as title, author, abstract, and the like. In comparison, journals and dissertations have a different, but similar, data source types and are imported using a journal auto-import module 704. Journal articles and dissertations are similar in that they include the same type of summary data. However, journal articles and dissertations typically do not include the table of contents or index typically found in a book.

Ad hoc sources include those raw data sources that do not have a standard format. Information from ad hoc sources may be imported using a scraping module 706 or may be imported using manual keying 708.

The scraping module 706 can be, for example, a module configured to handle a particular ad hoc data source. For example, the scraping module 706 can import microfiche text, convert the text to an electronically readable format, and import the information into the database. In another embodiment, the scraping module 706 can download web pages, convert them to entities and relationships, and import the information into the database. The web pages can include information including, but not limited to, authors, publications, organizations, and the like, or some other information that is stored in the database. Publications can include articles, books, grants, clinical trials, and the like, or some other publication. The scraping module 706 can include multiple modules that are each configured to import data from a different type of ad hoc data source.

In one embodiment, a scraping module 706 can be configured to convert grants to entities and relationships and import the information into the database. Grants, in this context, refer to grant proposals and grant awards. Grant proposals and grant awards differ from books and journal articles because a grant is typically related to a field of research or study that is yet to be performed. Additionally, a grant is typically associated with a value, such as a dollar amount. The ability to import grant values and grant information allows a researcher to search the discipline specific database for information relating to the most lucrative grant values, whether proposals or awards, and the persons associated with that grant. Such information can reveal, for example, information disclosing the most active participants in a field of study.

Data from sources that are so unique as to only occur a minimal number of times can be imported using manual keying 708. For example, data from a handwritten manuscript may not be conducive to electronic import and may need to be imported using manual keying 708.

As was discussed earlier, data that is imported into the database is imported as a surface form. A surface form is how the data looked when it was imported from the external source. One type of imported data, for example a book, may generate more than one surface form. For example, importing data regarding a specific book will generate a surface form entity for the book itself and a surface form entity for the author. Many different surface forms may identify the same information or entity. For example, a name will identify only one individual, however, that individual may be known by several different names. For example, the individual may be named according to their first name and last name, their first initial and last name, or their first initial, middle initial and last name. A definitive form represents the true data identity. Each of the surface forms identifying that entity are linked to the definitive form.

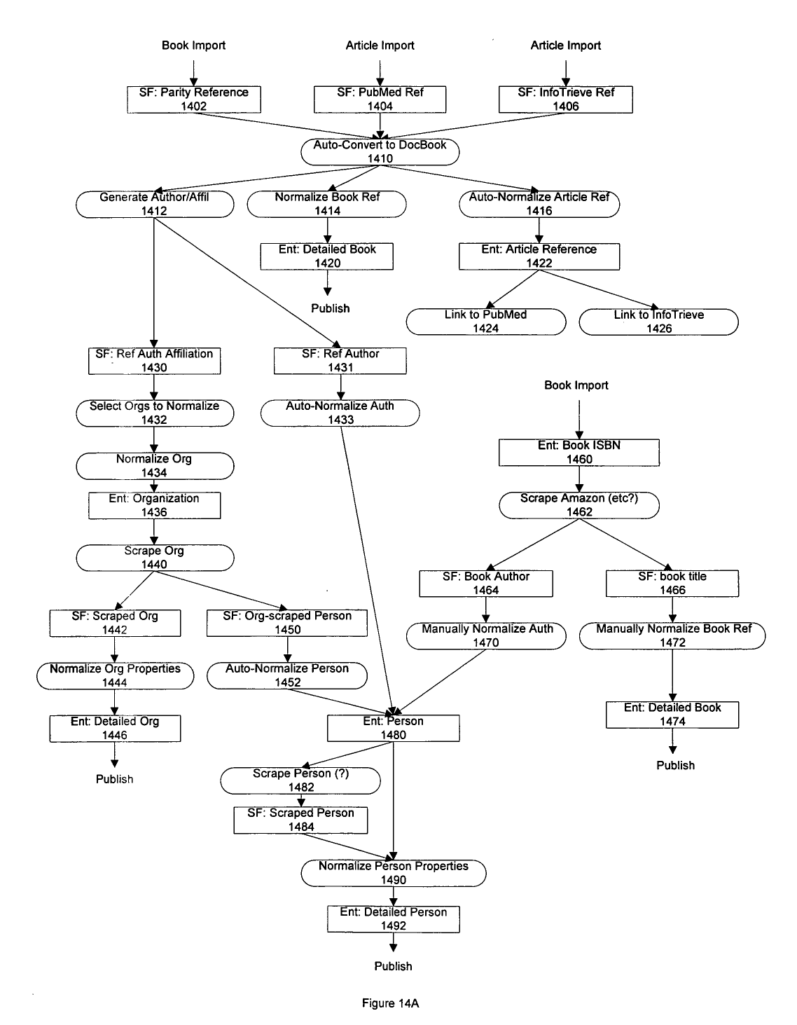

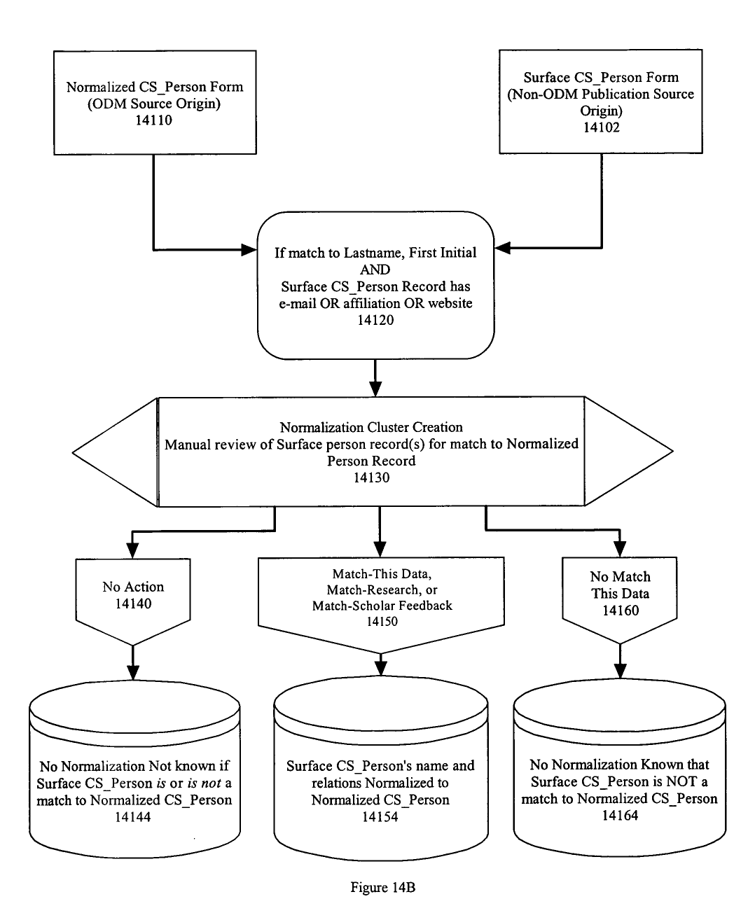

Thus, each of the data import modules, 702, 704, 706, and 708 links to a normalization module 710. The normalization module 710 converts some or all of the surface forms from the import modules to definitive forms. An embodiment of a normalization module 710 is provided below in FIG. 14A.

The output of the normalization module 710 is coupled to or imported to a publication module 720. That data can include definitive form entities and can also include surface form entities. The publication module 720 examines the imported data and prepares it for access by, for example, the search engine. One aspect of the operation of the publication module is indexing. The imported data can be indexed in one or more fashions in order to optimize specific types or categories of searching which will be carried out by the search engine. For example, in one embodiment the data is indexed for key word searching of the various types of publications contained within the database. Alternatively, the database can be indexed such that each person entity has an associated collection of publications. Alternatively, only the key words from publications authored by a person entity would be in the index for each person. In that way key word searching can be performed upon the collection of publications determined through normalization likely to be authored by or associated with an individual (for example, a definitive form person entity). For example, such an index allows the boolean search of “neurology and dendrite” to identify person entities whose total collection of publications meets the boolean criteria. For example such an index does not require that both terms appear in the same publication. This indexing can use the publications of the person entity to stand for or represent the expertise or interest of the person entity. Alternatively, different types of indexes can be created by the publication module 720.

In addition, the publication module 720 can remove or suppress selected parts of the data base. For example, attributes having associated meta data with a low believability can be suppressed or removed by the publication module 720. Alternatively, the data base can be published in different forms for different clients, purposes, or service levels. Clients interested in only certain attributes or certain types of searching can have the data base published for them with undesired attributes (or entity types) removed and desired indexes created. For example, the data base can be published use by users interested in identifying experts with selected expertise, identifying institutions which fund specific types of research, or identifying prospective students.

Further, the database can be published without searchable indexes, but in such a way that published entities could be imported by or integrated directly within some other database system. For example, in one embodiment, person entities could be published for direct integration within a customer relationship management system (CRM), which may not require direct searching across entities. In this embodiment, surface form person entities created in the CRM system by sales or marketing representatives could be imported to the database. These surface forms are then normalized using other data from the CRM system and/or data imported from other data sources. Such sources could be automatically imported, manually entered from ad hoc sources, or input using some combination of automatic and manual processes. Normalized information, which may include standardized entity representations and other information resulting from the normalization process, can then be published so as to provide direct access by the CRM system and/or by the sales and marketing representatives. This embodiment could be implemented with a subset of the database system as described in other example implementations.

The output of the publication module 720 is coupled to a QA or staging server 730. In one embodiment, the staging server of FIG. 7 coincides with the staging server 30 of FIG. 1. The QA or staging server 730 can operate identically to a client server 740 except that the staging server 730 is not accessible by external clients. The staging server 730 can be accessed by an internal process or module to validate and verify the data imported from the raw sources.

Once the data has been validated in the staging server 730, the data (which can represent a discipline specific data base) is coupled or transferred from the staging server 730 to a client server 740. The client server 740 may be, for example, a personal computer or networked computer and may be the public server 40 of FIG. 1. The client server 740 may be accessed by a client computer 750 directly connected to the server. Alternatively, a client using a browser 760 may connect to the client server 740 over a network connection.

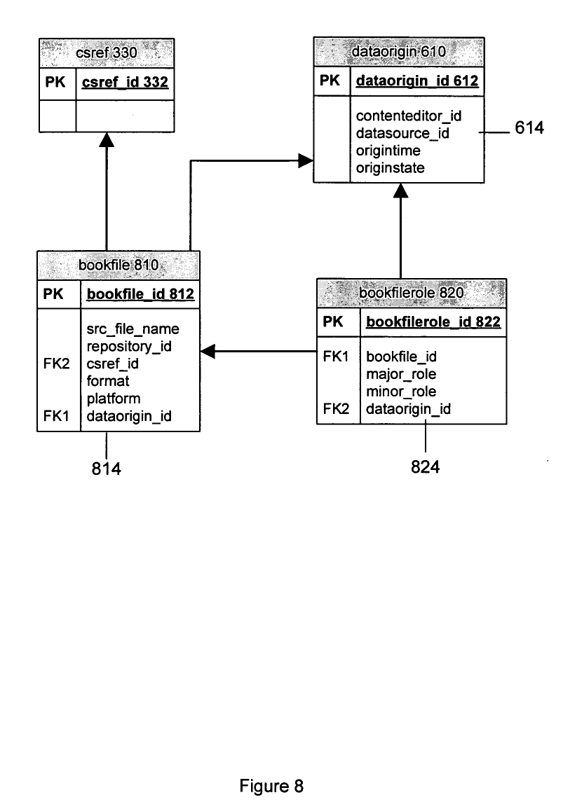

FIG. 8 is an application schema for a book import process. As will be seen in subsequent figures, the book import schema may be implemented in a single module or in a plurality of modules. The book import process can be used to import data from books or dissertations into the database. Reference to books in the description of the figure should be interpreted to mean books, dissertations, and other publications that can be imported using the book import process.

As shown in FIG. 7, a conversion module converts a raw book source file into a book file. The book file is identified as a record in a corresponding book file table 810. The book file can be linked to multiple book file roles and can be tagged with a data origin. The data origin table 610 may be identical to the data origin table of FIG. 3. The data origin table 610 identifies the source of the data, the time that data was imported into the database, and the system administrator or content editor that initiated the data import. The book file table includes foreign keys 814 that link the book file to a reference ID record, which is the entity record for the book.

Each imported book file refers to a single reference instance. Each imported book file can contain various content types. For example, a single book file can include a plurality of chapters, a table of contents, as well as an index.

The parsed book file is labeled in the book file role table 820. The book file role table 820 includes attributes 824 that identify the contents in the book file and the role that the content plays within the book file. For example, chapters may be identified as having different roles. Additionally, the index may be tagged as a book file role.

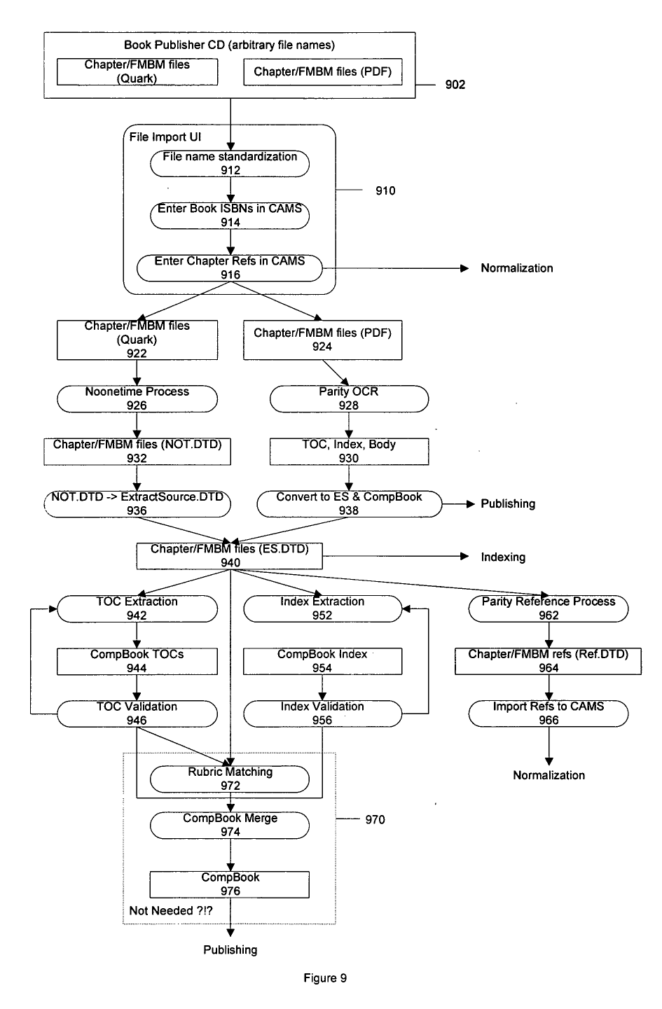

FIG. 9 is a functional block diagram of a book import system that can implement, for example, the book import schema of FIG. 8. The book import system of FIG. 9 is shown as comprising multiple modules. However, one or more of the modules may be combined into a single module.

The book import system performs importation of information from books that are in electronic file formats. For example, the electronic files may be Quark or PDF files. Although the book import system is shown as converting either Quark files or PDF files into XML data, other raw source file formats or other conversion formats may be used.

Electronic book files 902 are supplied to a file import user interface (UI) module 904. The file import user interface module 910 generates a filename and strips information such as a book ISBN from the electronic file. An automated file name standardization module 912 within the UI module 910 generates the file name. An ISBN extraction module 914 in the UI module 910 extracts the book ISBN. Additionally, a chapter extraction module 916 in the file import UI module 910 strips a chapter reference record from the electronic file. The filename ISBN and chapter reference numbers may be supplied in the electronic book file in a standard form. Alternatively, the filename ISBN and chapter references may be input into the file import user interface manually.

Once the file import user interface gathers the skeleton outline of the book, the book importation process can begin. The book import system shows two different book import processes. A first process is provided for Quark-encoded files. A second process is provided for PDF-encoded files. Regardless of file format, an extraction module initially extracts each chapter from the electronic book file and establishes a file for that chapter.

If the book is imported from a Quark file 922, the book import system processes the chapter files in a data conversion module 916. The data conversion module 916 creates an XML file conforming to a predetermined document type definition for each of the chapters and element types of the electronic book file. For example, an XML file conforming to a document type definition (DTD) is generated for each chapter, the table of contents and the index from the electronic book file. In one embodiment, the data conversion module 916 is a NOONETIME conversion process that creates an XML file 932 conforming to a NOONETIME DTD file.

The XML files 932 generated by the data conversion module 916 are then input to a second conversion module 936. The second conversion module 936 transforms the XML files 932 conforming to the NOONETIME DTD to, for example, XML files conforming to extract-source document type definitions.

Alternatively, if the electronic book file is in PDF format, the PDF file 924 is provided to an optical character recognition (OCR) module 928. The OCR module 928 transforms the PDF file 924 into a table of contents, index and body files 934. The OCR module 928 extracts the text from the PDF file for each of the file types.

The text files 934 output from the OCR module 928 are then provided to a conversion module 938. The conversion module 938 converts the text into XML files conforming to extract-source document-type definitions. Thus, the book files are transformed into extract-source DTD compliant XML files 940 regardless of source type.

The extract-source XML files 940, whether originating from Quark files, PDF files, or files having some other format, form the basis of the database extraction. A table of contents extraction module 942 extracts the table of contents information from the extract source XML files 940. The table of contents extraction module 942 transforms the table of content information into a computer book table of contents 944. The computer book table of contents 944 is then provided to a table of contents validation module 946. Similarly, index information from the extract source XML files 940 is extracted using an index extraction module 952. The index extraction module 952 generates a computer book index file 954. The computer book index file 954 is then provided to an index validation module 956.

The output of the table of contents and index validation modules, 946 and 956 respectively, are provided to a rubric matching module 972. The rubric matching module 972 operates on the rubric and body of the book. The rubric matching module 972 matches the book headings, such as chapter, sub-heading, and the like to the corresponding portion of the book body. The rubric matching module 972 can determine, for example, which table of contents line entries correspond to which sections in the book body. In the case of bibliographies, the rubric matching module 972 determines in which rubric a given citation occurs.

The output of the rubric matching module 972 is coupled to a computer book merge module 974. The computer book merge module 974 merges table of contents and index information into a computer book 976. The information in the table of contents and the information in the index are thus made accessible by the database.

The extract source XML file 940 also includes the body of the book. Information from the body of the book is extracted uses a parity reference module 962. The output of the parity reference module 962 is one or more chapter reference XML file 964. The chapter reference XML files 964 are provided to an import module 966. The import module 966 provides the body of the book to the database.

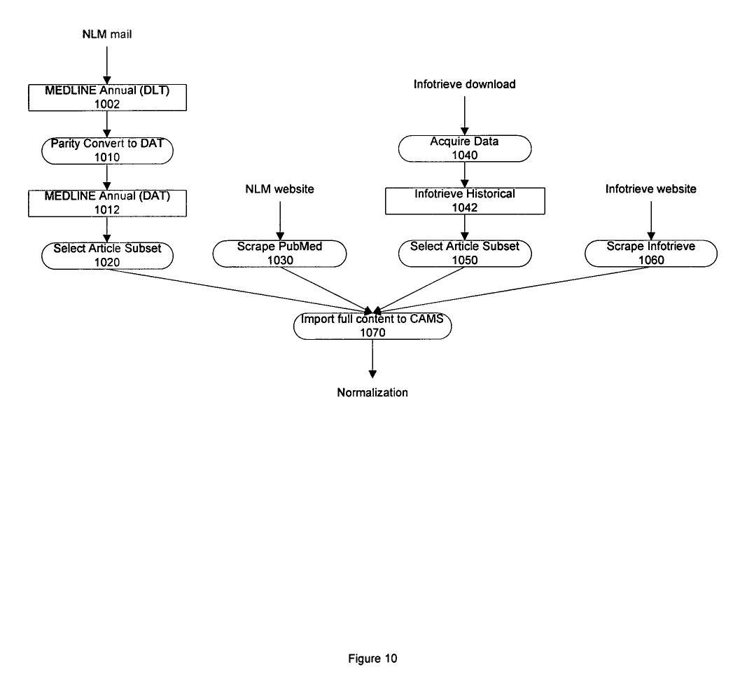

FIG. 10 is a functional block diagram of an embodiment of a journal article import system. The system is configured to import articles for a medical discipline-specific database. Alternative journal article import systems may similarly import journal articles into other discipline-specific databases.

The journal article import system is configured to import articles, such as articles from, for example, National Library of Medicine (NLM) databases, UMI databases, publisher databases, Infotrieve databases, or some other general content or data source. The information may be downloaded directly from the source or may be scraped from a website. For example, National Library of Medicine information may be received from a MedLine Annual Update or may alternatively be derived from a National Library of Medicine website.

The National Library of Medicine annually produces an update of its MedLine database. The MedLine Annual Update is available as a DLT tape or alternatively through FTP Download. The MedLine Annual DLT tape 1002 may be converted one or more times to extract the database information.

For example, an initial database converter 1010 may convert the MedLine Annual DLT tape 1002 to a DAT format 1012. The information in the converted MedLine Annual DAT tape 1012 is then mined using a database selector 1020. The database selector 1020 is configured to select those articles or subsets of the MedLine database that are to be included in the discipline-specific database. The subset of articles selected by the database selector 1020 is then coupled to a database import module 1070. The database import module 1070 parses the data in the subset of articles selected by the database selector and imports the data to the database.

More current articles or recently published articles that are not included in the MedLine Annual Update may be downloaded directly from the National Library of Medicine website. A database scraping module 1030 may connect with the National Library of Medicine website. The database scraping module 1030 may, for example, connect to the PubMed database supported by the National Library of Medicine. The database scraping module 1030 may then scrape the PubMed database to retrieve the relevant journal articles. Scraping refers to the acts of searching, identifying and selecting relevant articles (or other entities). The relevant articles are scraped from the National Library of Medicine PubMed database. The database scraping module 1030 produces a subset of articles that are relevant to the discipline-specific database. The database scraping module 1030 may perform searches, for example, using the keywords from a lexicon entity or ontology entity. Journal articles selected by the database scraping module 1030 are coupled to the database import module 1070.

Information may similarly be downloaded from the Infotrieve database, a general content or data source, or directly from publisher databases. One or more journals or journal articles accessible through Infotrieve or another content source may also be accessible through the National Library of Medicine database. The Infotrieve journal article database information may also be imported directly from Infotrieve or via the Infotrieve website. Alternatively, journal articles may be imported directly from connections to publisher databases or may be downloaded via publisher websites. Journal articles may be imported from any general content or data source.

In one embodiment, data acquisition module 1040 may download information from a general content or data source. The data acquisition module 1040 may, for example, download historical or archival data 1042 from a source database. Blocks of historical or archival information 1042 are then forwarded to an article selector 1050. The article selector 1050 searches, identifies and selects the subset of articles that are relevant to the discipline-specific database. The selected subset of articles is then coupled to the data import module 1070 for importation into the discipline-specific database.

A journal scraping module 1060 may connect with a general content or data source website. The journal scraping module 1060 may periodically search and retrieve relevant articles from the general content or data source website. As was the case with the PubMed scraping module 1030, the journal scraping module 1060 may receive search terms from the lexicon or ontology entities. Journal articles that are identified by the journal scraping module 1060 are forwarded to the database import module.

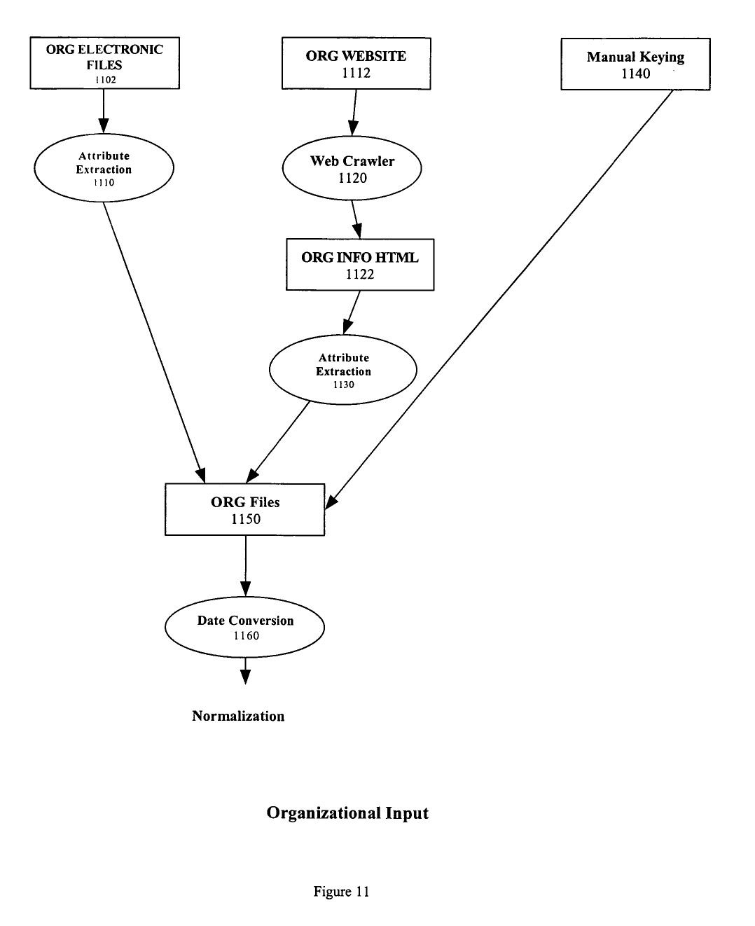

FIG. 11 is a functional block diagram of an organization import module. The organization import module can accept information electronically through files, through a website or using manual keying.

Organization information may be formatted in an electronic file 1102. Such an electronic file 1102 may, for example, be supplied by the organization in response to a survey or form. Alternatively, a third party may generate the organization electronic file 1102.

The organization electronic file 1102 is provided to an attribute extraction module 1110. The attribute extraction module 1110 extracts the relevant information and generates one or more organization files 1150. Relevant information is that information which is relevant to the discipline-specific database. For example, a university may have one or more departments. However, only one of the departments may be relevant to a specific database.

Similarly, information may be retrieved from an organization's website 1112. A web crawler 1120 or similar robot may access the organization's website 1112 and retrieve information from that website. The web crawler 1112 may deposit all the retrieved information into a temporary organization information file 1122. The temporary organization information file 1122 may, for example, be HTML pages retrieved from the organization website 1112.

The temporary organization information file 1122 is provided to an attribute extraction module 1130. The attribute extraction module 1130 accesses the temporary organization information file 1122 and extracts the relevant database information. The attribute extraction module 1130 then generates one or more organization files 1150 that are relevant to the discipline-specific database.

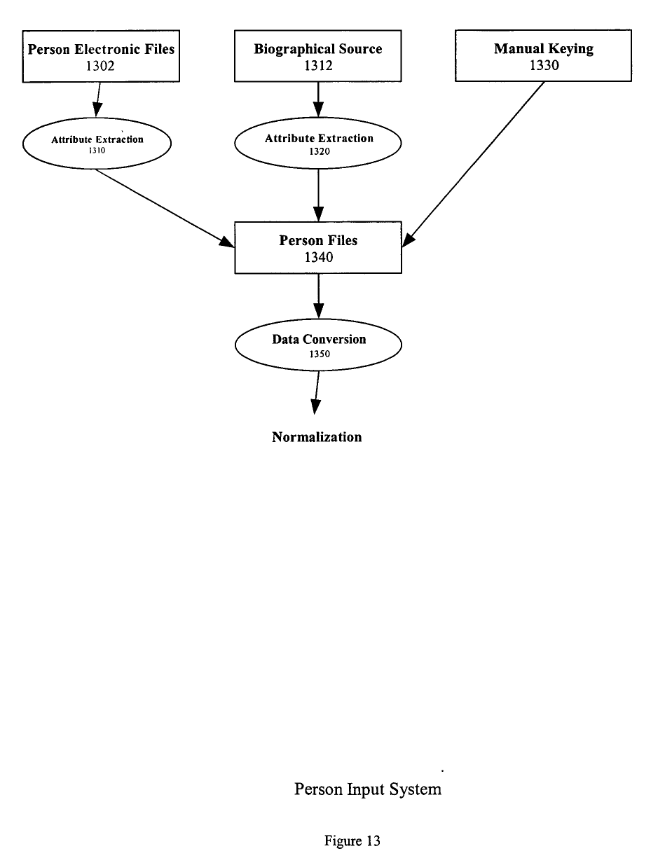

Alternatively, organization information may be input into the discipline-specific database via manual keying 1140. One or more individuals having knowledge of the organization may generate the one or more organization files 1140 using an Organization Data Management (ODM) interface configured according to the schema described in FIG. 6. The ODM interface can be, for example, implemented in the content aggregation management and staging module shown in FIG. 1. The organization is modeled following the org-entity relationships of parent org and child org to hierarchically build the organization beginning with the main organization, such as a university, followed by one or more discipline relevant child organizations. The ODM interface further provides the opportunity to manually enter people information (1330) as shown in FIG. 13.

The one or more organization files 1150 are provided to a data conversion module 1160. The data conversion module extracts 1160 the entity and attribute information and populates the corresponding tables in the discipline-specific database. The data conversion module 1160 may also transform the organization files into a desired database format, for example, XML. The output of the data conversion module 1160 is provided to a normalization module. The normalization module converts the surface forms from the data conversion module into the equivalent definitive forms.

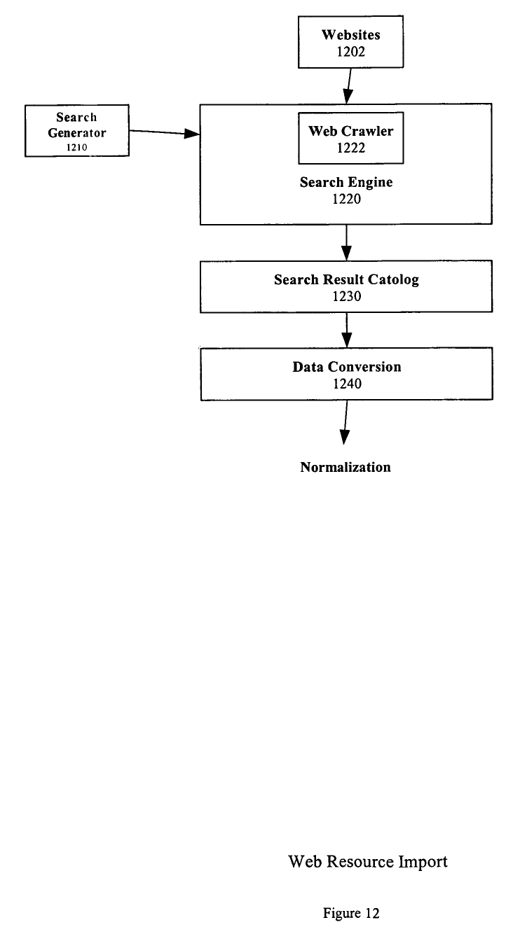

FIG. 12 is a functional block diagram of one embodiment of a web resource import system. The system searches Internet websites 1202 that have information relevant to the discipline-specific database.

A search engine 1220 having a web crawler 1222 connects to websites 1202 over the Internet. In the first embodiment, the web crawler 1222 successively crawls through Internet websites 1202 and catalogs all websites encountered. A search generator 1210 generates one or more search terms that are input to the search engine 1220. The search generator 1220 can generate search queries using, for example, keywords from the lexicon or ontology entity. The search engine 1220 returns a list of web pages that match the search terms. The search engine 1220 stores the list of matches in the search result catalog 1230.

A data conversion module 1240 accesses the search result catalog 1230 and extracts the information from the web pages. The data conversion module 1240 parses and stores the information from the web pages in appropriate entity tables in the database. The data conversion module 1240 also generates the relationships and relationship attributes linking the information from the websites to other entities. The information output by the data conversion module 1240 is provided to a normalization module.

FIG. 13 is a functional block diagram of one embodiment of a system for the input of person entities. The system is optional in the content aggregation system because the majority of information relating to a person is available through bibliographical sources or web resources.

Data relating to a person may be supplied via electronic files 1302, biographical sources 1312, or via manual keying 1330. An electronic file 1302 having personal information may be generated, for example, by a natural form representative or a third party in response to a survey or questionnaire or upon noting an error in the data. For example, a person using the data base system could note an error and supply the correct information. Further, surveys developed from definitive form entity representations can be used to solicit additional information from natural form representatives with potentially higher response rates and richer data submission than providing blank forms for self description by natural form representatives. Alternatively, electronic files may be generated from manually keyed inputs to other coupled systems, such as sales or marketing representative inputs to a customer relationship management system. The electronic file 1302 is provided to an attribute extraction module 1310. The attribute extraction module 1310 extracts the relevant personal information and generates one or more person files 1340.

Personal information may also be extracted by biographical sources 1312. Biographical sources 1312 can include books, such as who's who books, and industry catalogs of individuals active in the area of interest. The biographical source 1312 is coupled to an attribute extraction module 1320. The attribute extraction module 1320 extracts the relevant biographical information and generates one or more person files 1340.

The person files may alternatively be generated manually by an operator using the ODM interface described in the organization input module of FIG. 11. An operator having knowledge of the personal information, through the ODM process of modeling parent organizations, their one or more child organizations, and members of those organizations can manually key 1330 the data into one or more person files 1340. Alternatively, an operator, or system administrator, can obtain personal information knowledge through other sources and manually input that information using the ODM interface.

When person files are created through the ODM process, the membership relationships between a person entity and an organization entity can be entered manually. For example, the memberof relationship can be manually entered into predetermined fields that the ODM interface provides to an operator entering person information.

The person files 1340 can include one or more tables having the person's name as the record and attributes of that person included in that record. Attributes can include, for example, organizations with which that person is a member or degrees granted to that person. The person files 1340 are provided to a data conversion module 1350 that parses the data and inputs the data into the discipline-specific database. The data conversion module 1350 may also generate surface forms of other entities and the relationships and relationship attributes based on the person files. For example, person files may include bibliographic references to publications authored by a specific person; such bibliographic references could generate surface forms of the document entities and co-author person entities. The output of the data conversion module 1350 is provided to a normalization module.

Each of the foregoing processes of importing information or data into the system also can include the opportunity to add meta data to each entity and/or attribute. One embodiment of meta data has been described above.

FIG. 14A is a functional block diagram of a normalization module. The normalization module of FIG. 14A can be used, for example, in the import processes of FIGS. 9-13. The normalization module is shown as operating on data from book import or journal article import systems. However, the normalization module can also operate on the data provided from other sources such as the organization input, person input, grant input, web resource input modules, or from input provided by natural form representatives.

The book import module, such as the book import module shown in FIG. 9, generates a surface form of the book 1402. Similarly, the journal article import module of FIG. 10 generates a surface form of the article. For example, the journal article import module can generate a surface form of a PubMed reference 1404. Similarly, the journal article import module can generate a surface form of an Infotrieve reference 1406 or a reference imported from a general content or data source.

Each of the surface forms generated by the respective import modules is converted into a common document book format in an auto-conversion module 1410.

A book reference normalizer 1414 accesses the standard document book files and extracts the entity relating to the surface forms of the book. In the case of the book import, the book reference normalizer's task is trivial. The surface form of the book imported in the book import process is the same as the book entity. In the case of document book files generated by the article import process, the book reference normalizer 1414 accesses the bibliography of the articles and maps the surface forms of the book to the book entity 1420.

Similarly, an article reference normalizer 1416 accesses surface forms of articles and maps them to the appropriate article entities. Surface forms of article references may be generated in the article import process. Alternatively, surface forms of articles may be generated in the bibliographies of books or articles, or in lists of publications authored by individuals, for example in a person's CV. The various surface forms are mapped to the actual article entity 1422.

An author or affiliation generator 1412 extracts the author and organization surface forms, 1431 and 1430 respectively, from the document books. The various author (person) surface form entities 1431 can be mapped to the person definitive form entities 1480 using an auto-normalizing module 1433 or a manual normalization process.

The author or affiliation generator 1412 also generates surface forms of affiliations 1430. One or more of the surface form affiliations 1430 may be selected for normalization in a data selector module 1432. The organization normalizer 1434 maps the surface form of the affiliation 1430 to the organization entity 1436.

Additional organization information may be generated by an organization scraping module 1440. The organization scraping module 1440 generates a surface form of the scraped organization 1442. An organization normalizer 1444 normalizes those organization properties generated by the scraping. The scraped organization surface forms 1442 may be mapped back to the original organization entity 1436 or may alternatively be mapped to a detailed organization entity 1446.

The organization scraping module 1440 may also generate scraped person surface forms 1450. The scraped person surface forms 1450 are normalized to the corresponding person definitive form entities 1480 in an auto-person normalization module 1452. A person entity 1480 may have one or more normalized person properties 1490 or attributes. Attributes can obtained by scraping (searching relevant sources) 1482. Those attributes or properties 1484 can them be normalized. The normalization of various person surface forms to a definitive person form can be achieved manually or through an automated process or a combination of both.

The normalization process begins with the auto-creation of a normalization cluster in which a definitive person form is presented as a target, and one or more person surface form(s) that meet selected criteria are included in the cluster for possible normalization. The criteria can include, for example, match to last name and first initial, with either affiliation, e-mail, or website. Additionally, the meta data associated with each of those attributes can also be factored into the criteria.

In one embodiment the normalization process follows an evidence based process of review in which key distinguishing attributes and relationships are evaluated to determine if the surface person form name is a match to the definitive person form. Such attributes can include, but are not limited to, affiliation, e-mail address, author records, self-review by a natural form representative, website information, and the like. In addition the weight attached to each such piece of evidence can be varied by the associated meta data, such as the source and belief meta data. The various distinguishing attributes and relationships are used to normalize the various person surface forms to a canonical representation of the person entity. Based at least in part on the evidence derived from examining the attributes and relationships, or lack thereof, a surface form person can be normalized to a definitive person form, and the normalized attributes 1490 may map the person entity to a more detailed person entity. For example, a web crawler can be used to search the online information describing natural form person entities (for example, available at university website) to obtain lists of new publications by the entity. Such evidence can then be used to normalize a publication.

Another possible outcome when performing a normalization process includes performing no action when there is insufficient evidence to determine if there is a match of the surface form to the definitive form. Still another action that can occur when performing normalization is determining “no match” when the process determines that the surface form or a person does not match the definitive person form.

The book import module may also generate book ISBN entities 1460. The book ISBN entities 1460 are entities as well as surface forms of the book ISBN. Book ISBNs can be obtained, for example, by a scraping module 1462 that performs a scraping operation on a book database, such as the Amazon database.

The book ISBN entity 1460 may have attributes that are surface forms of book authors 1464 and surface forms of the book title 1466. The surface forms of the book author 1464 or of book authors or journal articles that are referenced in the book bibliography are normalized to person definitive form entities 1480 using a book author normalizer 1470. Similarly, the surface form of the book title 1466 is normalized to a detailed book entity 1474 using a book reference normalizer 1472. The functions of the book author normalizer 1470 as well as the book reference normalizer 1472 may be performed automatically, or may alternatively be performed manually.

FIG. 14A shows a normalization module that is configured to perform normalization across different entity types. That is, the normalization module of FIG. 14A can perform normalization of authors, books, and articles, which correspond to person and publication entity types. In another embodiment, normalization of different entity types can be performed in modules adapted for that entity type. For example, a normalization module can be used to normalize organization surface forms to definitive surface forms, and a separate normalization module can be used to normalize surface forms of persons to definitive person forms.

FIG. 14B is a functional block diagram of a normalization module configured to normalize a surface form of a person to a definitive form of the person. The normalization module implements an evidence based process of review as described above in relation to FIG. 14A. A discipline specific database system may incorporate one or more modules similar to the module shown in FIG. 14B. Each of the modules can be adapted to perform normalization of one or more entity types.

The module begins by retrieving a surface form record 14102 and a definitive form record 14110. Each of the records 14102 and 14110 can be, for example, records previously imported into the discipline-specific database by the content aggregation management and staging module 20 of FIG. 1. Additionally, the records 14102 and 14110 can be stored in a location of the database 50 that is not accessible by the staging server 30 or the public server 40 until after the surface form record 14102 has been normalized.

In FIG. 14B, the surface form record 14102 is shown as a surface form record of a person. Similarly, the definitive form record 14110 is shown as a definitive form of a person. However, other normalization modules will compare records corresponding to the particular entity type being normalized. In one embodiment, the definitive form record 14110 corresponds to a record that was previously normalized, or one that was manually entered and designated as the definitive record.

The retrieved records 14102 and 14110 are then provided to a criteria matching module 14120. The criteria matching module 14120 determines the likelihood that the surface form record 14102 corresponds to the definitive form record 14110. The criteria matching module 14120 can use an evidence based process of review. One or more attributes and relationships can be used as evidence to support or eliminate a match between a surface from and a definitive form. Additionally, the meta data associated with each of those attributes can also be factored into the criteria.

In one embodiment, the criteria matching module 14120 can compare the last name and first initial of a surface person record 14102 to the corresponding attributes of the definitive person record 14110. Additionally, the criteria matching module 14120 can determine if an email address, affiliation, or website associated with the surface form record 14102 matches one associated with the definitive form record 14110. As was mentioned above, associated meta data can also be used. For example, an email address may have an associated start and end date when a person has changed employers and therefore, changed email addresses.

As can be seen, the criteria matching module 14120 can be configured to perform any boolean operation with the attributes, relations and associated meta data associated with a definitive form. Of course, although a boolean operation may be advantageous, the criteria matching module 14120 is not limited to performing boolean operations. Additionally, the criteria matching module 14120 can perform one or more comparison operations and determine one or more matching results. The matching results can be equally weighted or can be weighted according to a rank or hierarchy. Thus, a match to a last name may be weighted more heavily than a first name match or an affiliation match.

The criteria matching module 14120 provides the results of the one or more matching determinations to a normalization cluster creation module 14130. The normalization cluster creation module 14130 determines, based at least in part on the results received from the criteria matching module 14120, whether the surface form record 14102 corresponds to the definitive form record 14110. The normalization cluster creation module 14130 can, for example, compare a matching score against one or more predetermined matching thresholds. The normalization cluster creation module 14130 can then determine a link or relationship between a surface form record 14102 and a definitive form record 14110. This effectively creates a link with very high confidence between the definitive form person entity and the definitive form publication entities connected by the normalization of the surface form person entity described in the document record.

The normalization cluster creation module 14130 can determine that the results from the criteria matching module 14120 are inconclusive, and that it is not possible to conclusively determine (as defined by selected criteria) the surface form record 14102 corresponds to the definitive form record 14110. Additionally, there may not be sufficient information to conclusively determine that the surface form record 14102 does not correspond to the definitive form record 14110. In this case, the normalization cluster creation module 14130 performs no action 14140 and the surface form record 14102 remains in the database without a linkage to the definitive form record 14110. In one embodiment, the normalization cluster creation module 14130 may set a flag, attribute, or some other indicator to indicate that the surface form record 14102 has been checked against the definitive form record 14110. The modified surface form record 14102 is then saved in the database 14144.

In one embodiment the saved unresolved surface form entities can be used as a target list of suspected natural forms. That is particularly useful when the unresolved surface forms form a cluster. In other words, if a group of unresolved surface forms appear to indicate the same natural form, and indicate a high enough probability that a common natural form exists and should be represented in the data base, potentially matching natural forms can be sought out, added in the database, normalized into a definitive form and normalized against the cluster of unresolved surface forms.

The normalization cluster creation module 14130 may determine that the surface form record 14102 matches the definitive form record 14110. In this case, the normalization cluster creation module 14130 determines a match 14150. The normalization cluster creation module 14130 may indicate the manner in which the match was determined or the evidence supporting the match. For example, the match may have been determined based on the results from the criteria matching module 14120 or may have been determined and entered manually based on additional research. A match may also have been determined manually by self verification by a natural form representative. That is, in the case of an author, the actual author may be consulted and verify that the surface form of a person derived from an article import is indeed the same person as represented by the definitive form entity. Alternatively, the author may have noticed a mistake in the data and provided a correction. The normalization cluster creation module 14130 may then indicate the match in the surface form record 14102 and the modified surface form record stored in the database 14154.

In another situation, the normalization cluster creation module 14130 can determine that the surface from record 14102 does not correspond to the definitive form record 14110. In this case, the normalization cluster creation module 14130 determines no match 14160. The normalization cluster creation module 14130 may then indicate the lack of match in the surface form record 14102 and the modified surface form record 14102 stored in the database 14164.

The process of matching surface form records 14102 to definitive form records 14110 can be repeated for each definitive form record 14110 in the database. Alternatively, the comparison may be performed until a match has been determined. The normalization module can then repeat the process for all of the surface form records 14102.

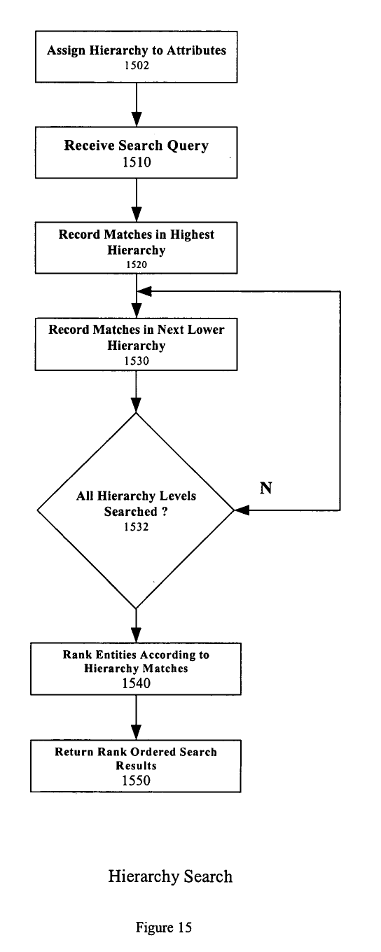

FIGS. 15, 16 and 17 are methods of searching that can be implemented, for example, in the public server 40 of FIG. 1. A search engine within the public server 40 can perform the methods shown in the figures. Although the flowcharts represent acts or steps in a particular order, the order of the steps or acts may not be a requirement of the method. Thus, some steps may be performed in an order not shown in the flowchart. Additionally, steps may be modified, omitted, or inserted into the flowcharts.

FIG. 15 is a flowchart of a method of a hierarchy search that may be performed by a search engine. Initially, the search engine assigns a hierarchy 1502 to attributes to be used in the search process. For example, a book entity may include a table of contents, title and index attributes. The search engine may assign a hierarchy to such attributes such as the title has precedence over the table of contents which may have precedence over the index.

Once the search engine has assigned a hierarchy to all possible search attributes, the search engine may receive search queries 1510. The search queries may be entered, for example, by a user using a public client in communication with the public server. The search engine initially compares the search query keywords against the highest hierarchy level. The search engine records the matches of the search query keywords to the highest hierarchy level 1520.

The search engine next moves one level down the hierarchy—from its current level and compares the search query against the records in the next lower hierarchy. The search engine also records the matches in the next lower hierarchy level 1530.

The search engine next proceeds to a decision block 1532 where the search engine verifies that all hierarchy levels have been searched. If all hierarchy levels have not been searched, the search engine loops back to block 1530 and proceeds to the next lower hierarchy level and searches that hierarchy level against the search query.

However, if all hierarchies have been searched, the search engine next ranks the entities retrieved from the search process according to the hierarchy matches 1540. That is, those entities which have matches in the higher levels of the hierarchy are ranked ahead of those entities which have matches in the lower hierarchy levels. The search engine next returns the rank or the search results to the user 1550. For example, the search engine may display the rank ordered search results in a browser running on the public client.

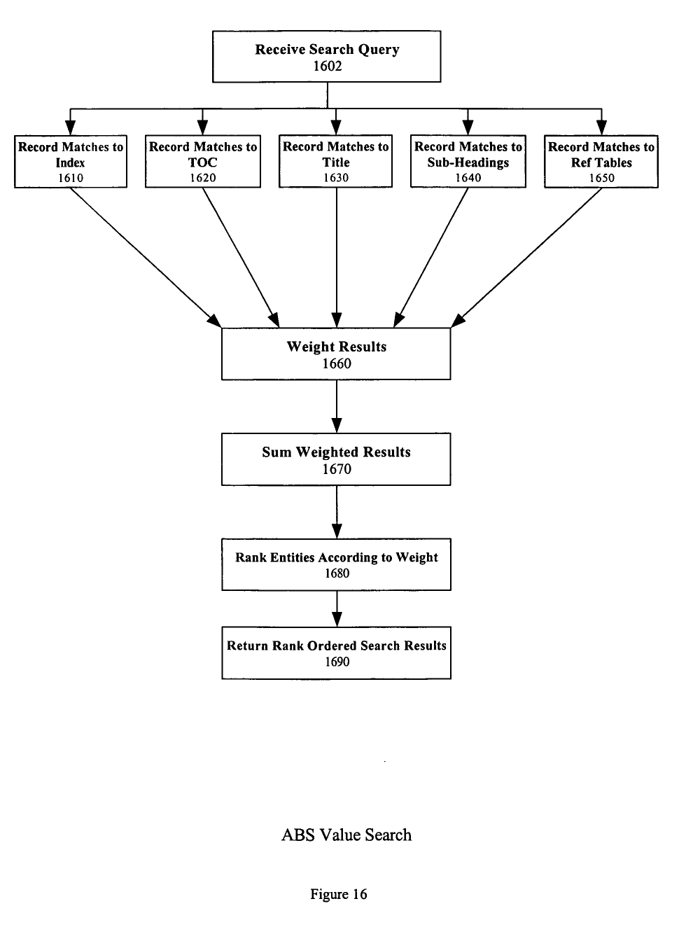

FIG. 16 is an alternate embodiment of a search method that can be run by a search engine. The search method uses an absolute value model and is not based on a hierarchy. The absolute value search method is based in part on the total number of keyword matches and is not based on the hierarchy of the matches.

The method begins when the search engine receives a search query 1602. The search engine may then either simultaneously or sequentially match the keywords in the search query to records in the database. In the method shown in FIG. 16, the search engine runs a simultaneous match.

The search engine records the number of matches of the keywords to index references 1610. Additionally, the search engine records the number of matches of the keywords to table of content entries 1620. Additionally, the search engine records the number of matches of the keywords in the search query to a title 1630. Similarly, the search engine records the number of keyword matches to subheadings 1640 or to reference tables 1650 within the various records.

The search engine next weights the results 1660. The results can be equally weighted or one or more results may be weighted higher than other results. Unequal weighting of the results can effectively result in a hierarchy of the various attributes.

Once the search engine weights the search results 1660, the weighted results are summed 1670. The search engine next ranks the entities 1680 derived for their weighted results based on their weighted sum. The search engine next returns a rank ordered listing 1690 of the search results.

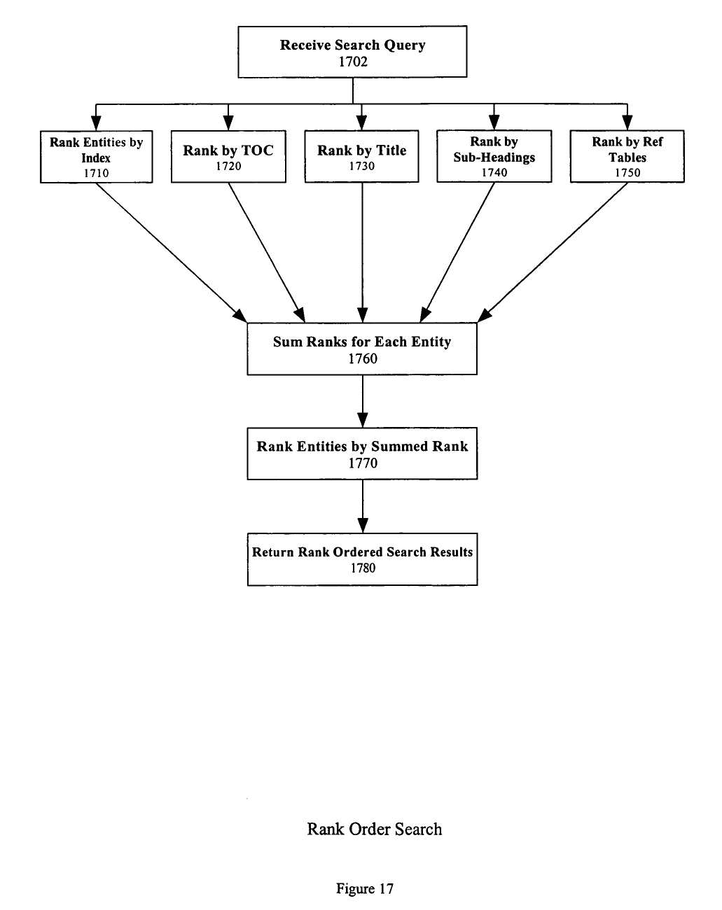

FIG. 17 is a flowchart of another method that can be performed by the search engine. FIG. 17 shows a rank ordered search where the search engine ranks entities according to various attributes. The rank ordered search results returned by the search engine are based in part on the rank of entities in each attribute category.

The search process begins when the search engine receives a search query 1702. The search engine next ranks entities according to various entity attributes. For example, the search engine may rank entities according to matches of the search query keywords with entries within an entity index 1710. Additionally, the search engine may rank entities according to matches to the entity table of contents entries 1720. The search engine may also rank entities by title 1730, subheadings 1840, or reference tables 1750. The search engine will thus create a plurality of rankings according to the various attributes. The search engine next sums the rankings from each of the entity attributes 1760.

The search engine next ranks the entities according to the summed rank 1770. It may be noted that the lower the summed rank, the higher the entity will rank in the overall rank order. Thus, the rank order is established based on the lowest numerical summed ranks. For example, an entity that ranks first in three rank categories will have a summed rank of three for those three categories. Any other entity can at best rank second in each of the categories and thus will have a summed rank of at least six. The search engine next returns the rank ordered list based on the summed rank 1780.

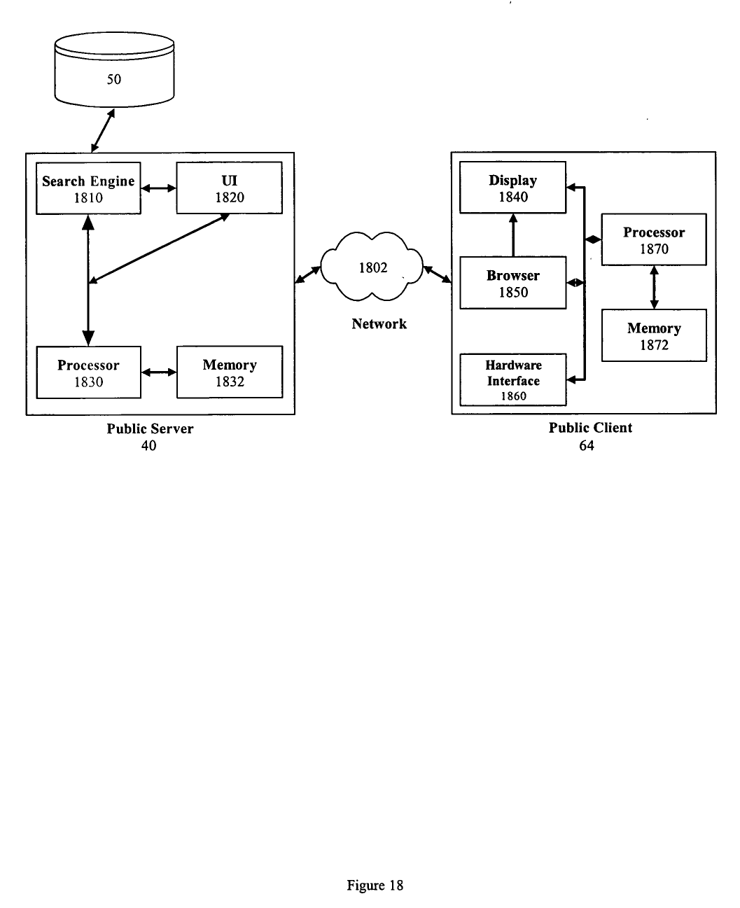

FIG. 18 is a functional block diagram of a discipline-specific database system. The system includes a database 50 having within it one or more discipline specific databases, coupled to a public server 40 that is also coupled to a network 1802. One or more public clients 64 can also be coupled to the network 1802.

The public server 40 can be, for example, a server or personal computer. The public server 40 includes a processor 1830 in communication with memory 1832. Additionally, the processor 1830 may be coupled to a search engine 1810 and a user interface module 1820. The public server 40, via the user interface module 1820 and search engine 1810, is in communication with the database 50.

The public client 64 may also be a personal computer. The public client 64 can include a processor 1870 coupled to memory 1872. Additionally, the public client 64 can include a hardware interface 1860 coupled to the processor 1870. The public client 64 may also include a browser 1850 and a display 1840 that are coupled to the processor 1870. The public client 64 can access the public server 40 via a network connection.

Typically, a user using the public client 64 can access the database 50 using a browser 1850 and the hardware interface 1860 of the public client 64. The public client 64 via the browser 1850 can access the user interface 1820 in the public server 40 in order to access and search the database 50. Alternatively, the functionality of the server 40 can be implemented on the public client which has direct access to the database 50.

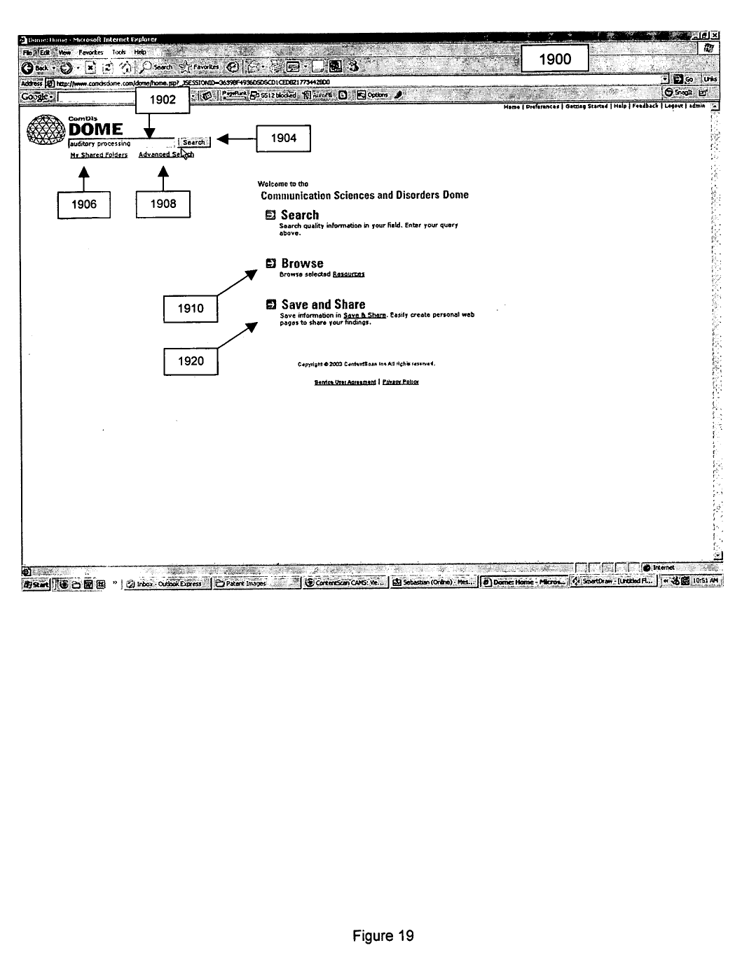

FIG. 19 is a screen shot of a search page 1900 that may be shown in the display of a public client when connected to the public server 40. The search entry page 1900 includes a search entry window 1902 or block. Although any key terms may be entered in the search window 1902, only those terms that appear within the discipline-specific database will be returned. For example, the search page 1900 shows the search page associated with a communicative disorders discipline-specific database. Any search can be entered in the search window 1902, however, only those results relating to communicative disorders will appear in the rank ordered list. In this example, the keyword search “auditory processing” is entered in the search window 1902.

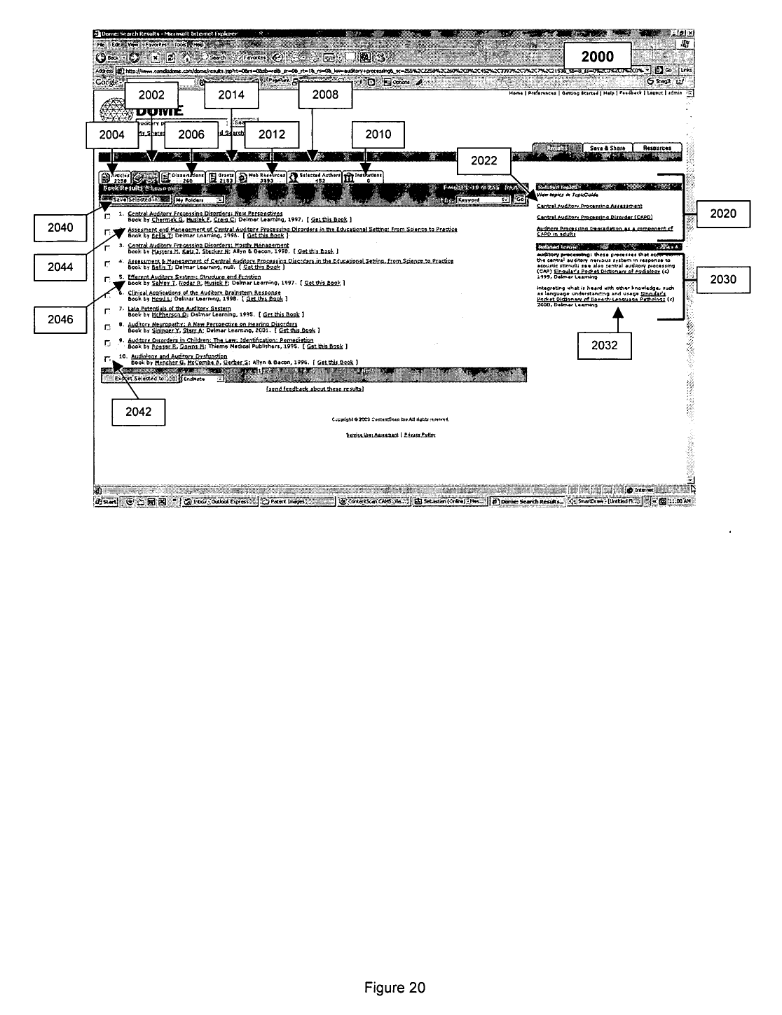

FIG. 20 is a screen shot of an embodiment of a search results page 2000. Rank ordered search results are provided for one or more categories. The rank ordered search results are returned and categorized in tabbed lists 2002-2014. The tabbed lists 2002-2014 loosely correspond to the entity types in the data model. For example, the tabbed lists 2002-2014 loosely correspond to the person, organization and publication entity types.

The tabs shown in FIG. 20 include a tab for books 2002, articles 2004, dissertations 2006, authors 2008, institutions 2010, web resources 2012 and grants 2014. A user may select each one of the tabs in order to display a rank ordered list of search results corresponding to that tab.

Additionally, the results page 2000 may show a listing of related topics 2020 or related terms 2030. The related topics 2020 and related terms 2030 may, for example, result from searches through the ontology or lexicon entities. Thus, a user that is not familiar with the lexicon of the particular discipline may be prompted using the related terms.

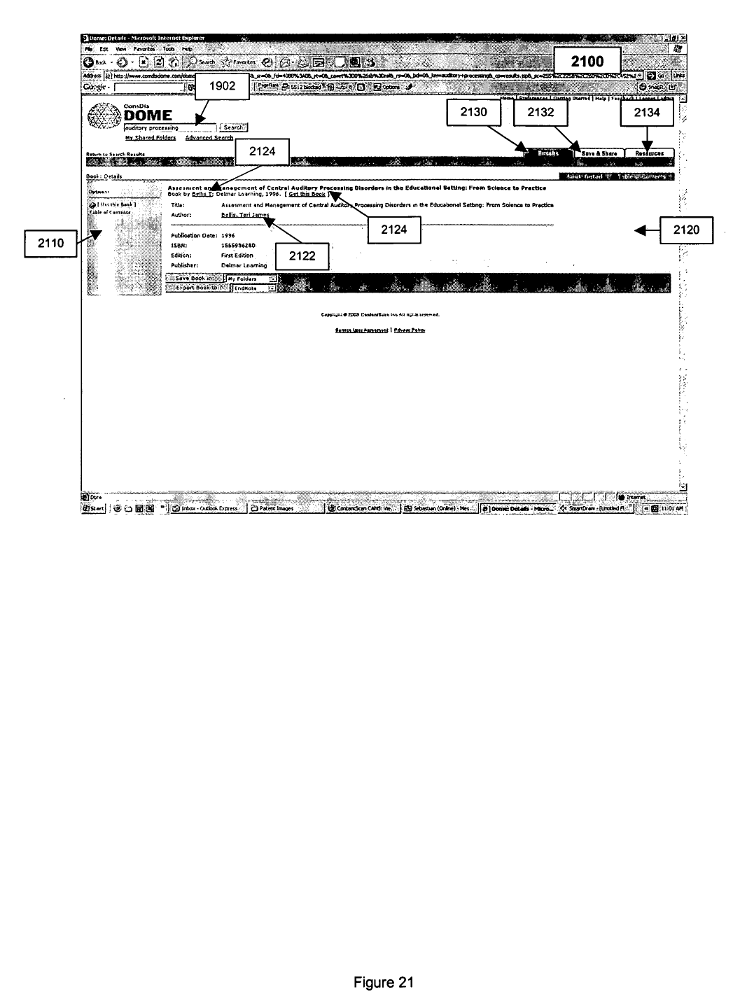

FIG. 21 is a screen shot of an embodiment of a detailed book listing 2100. The detailed book listing appears when a dynamic link identified by the book title is selected from the search results page 2000. The detailed book listing 2100 includes a detail display portion 2110 that includes details derived from the book, such as table of contents information. The detailed book listing 2100 also can include author and book summary information in a summary display portion 2120. The summary information can display the author's name as a dynamic link 2122. Selecting the author name dynamic link results in detailed author information to be displayed.

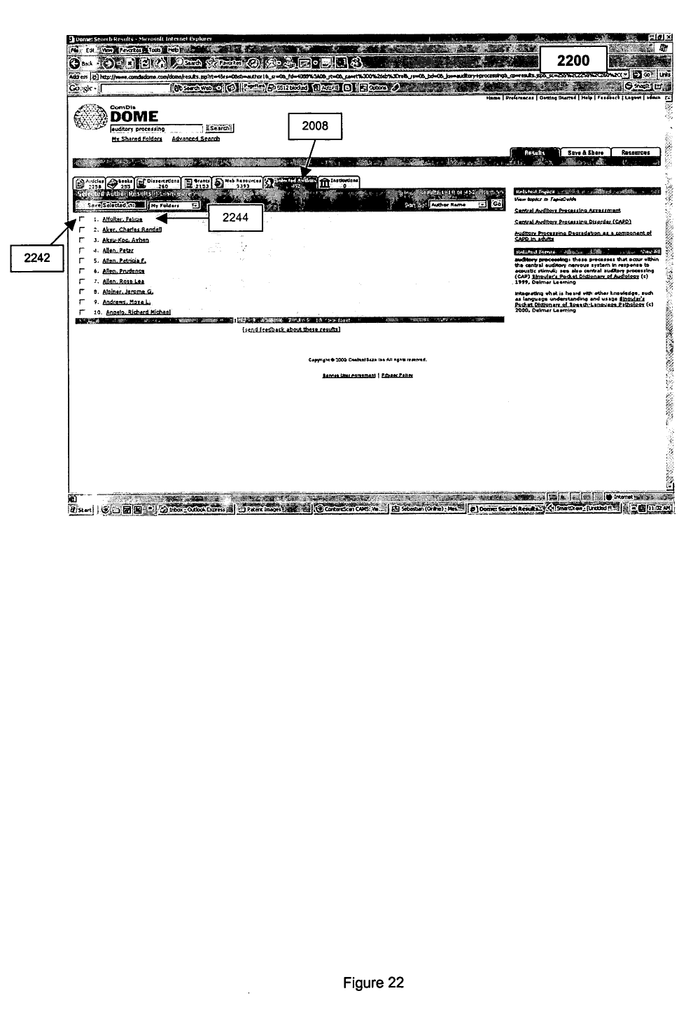

FIG. 22 is a screen shot of an embodiment of the author list display 2200 that results when the selected authors tab 2008 is selected. In this embodiment, the list of authors is provided alphabetically. However, in alternative embodiments, the list of authors may be provided in a rank order. The rank order may be established based on the rank order of one or more of the other tabbed lists. For example, the rank order of authors may be ordered based on the rank order of books in the books tab, or may be ordered by a weighted composition of the rank order or publication score across one or more tabs. Each author is shown as a dynamic link. Highlighting and selecting the author links the display to an expansion of the author. Alternatively, for key word to person searching, the rank ordering can be based on a set of indexes created for each person (definintive and or surface form entities) by aggregating information in associated documents across those documents.

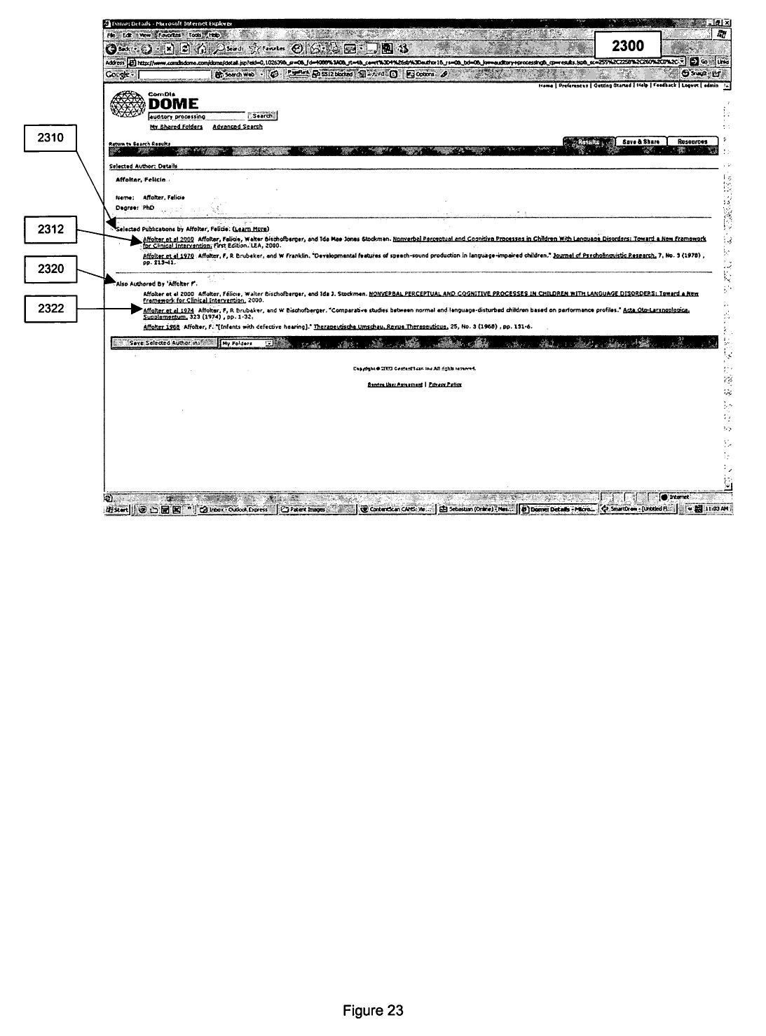

FIG. 23 is an embodiment of a screen shot of an expanded author listing 2300. The expanded author listing 2300 shown in FIG. 23 represents the author listing when the first author listed in the author list 2200 is selected. The expanded author listing 2300 provides the name of the author, the degrees granted to the author and selected publications 2310. The selected publications 2310 may include journal articles 2322, books 2312, grants and dissertations. Additionally, the selected publications 2310 may be limited to those publications that may be categorized within the discipline-specific database. Thus, articles and books that are authored by the selected author that do not fall within the discipline-specific database may or may not be shown in the selected publications. Additionally, publications with insufficient information to support normalization of a surface form author entity to the definitive form person entity may be represented within a separately identified section of the expanded author listing, such as “also authored by [first initial] [last name]”.

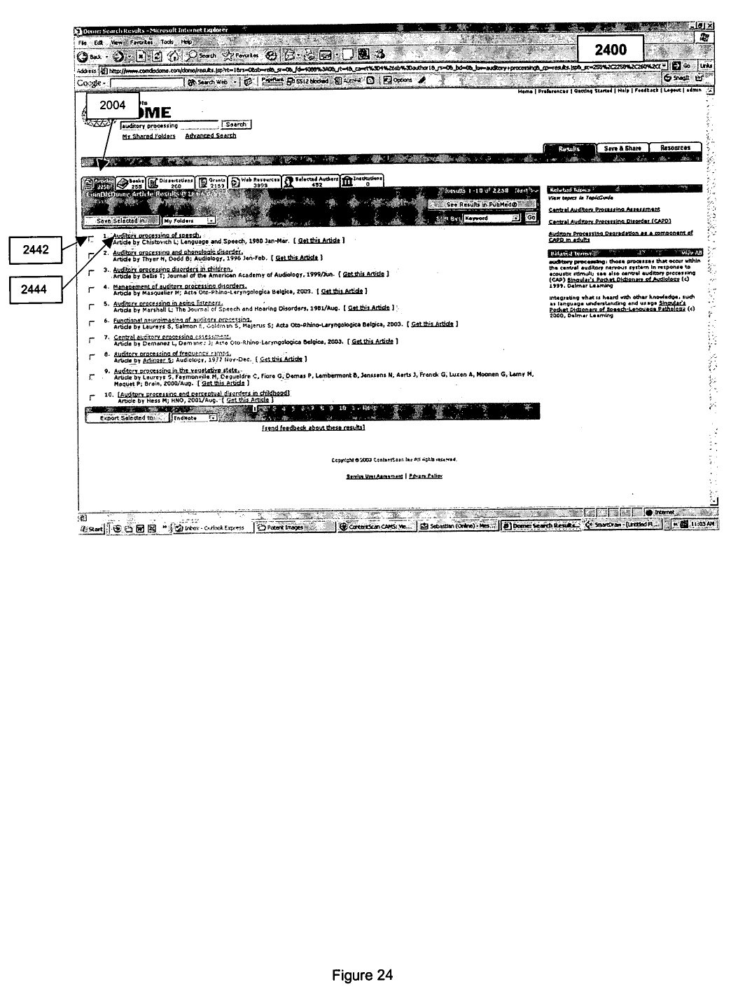

FIG. 24 represents an embodiment of a screen shot 2400 of the results page when the articles tab 2004 is selected. As with the other results in the results page, the articles page 2400 may only show those articles that return discipline-specific information. Each article, for example 2444 listed in the rank ordered list is shown as a dynamic link to another expanded view of the article. Additionally, a link is provided to either download or purchase the article.

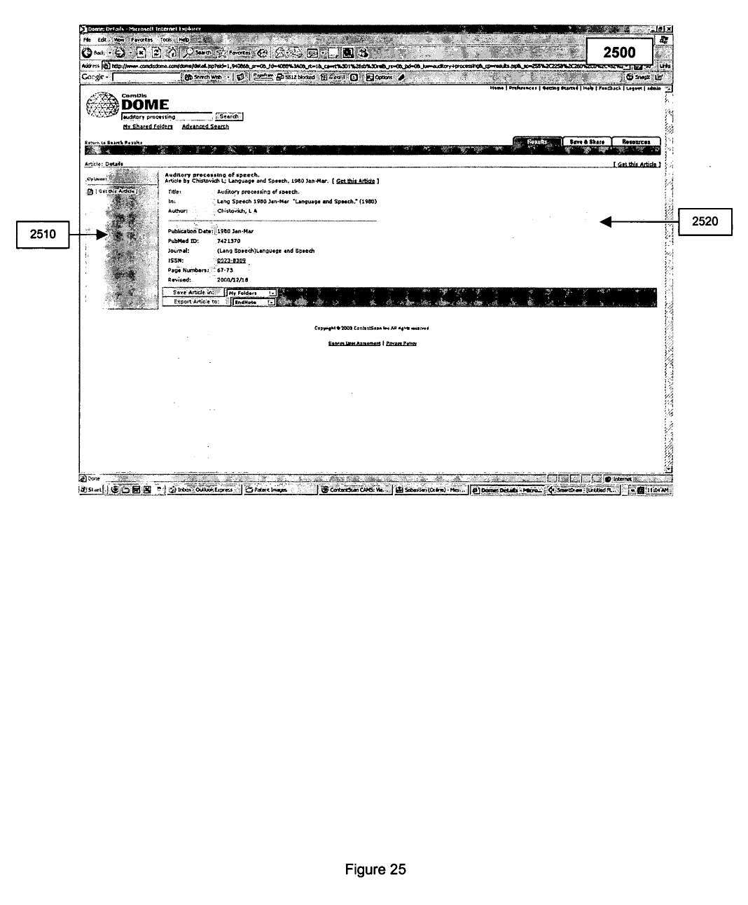

FIG. 25 is an embodiment of a screen shot of an expanded article page 2500 that appears when the first article 2444 listed in the articles tab is selected. The expanded article view shows the bibliographic information related to the highlighted article. Additionally, the screen shows the ability to save the article in a folder or export the article.

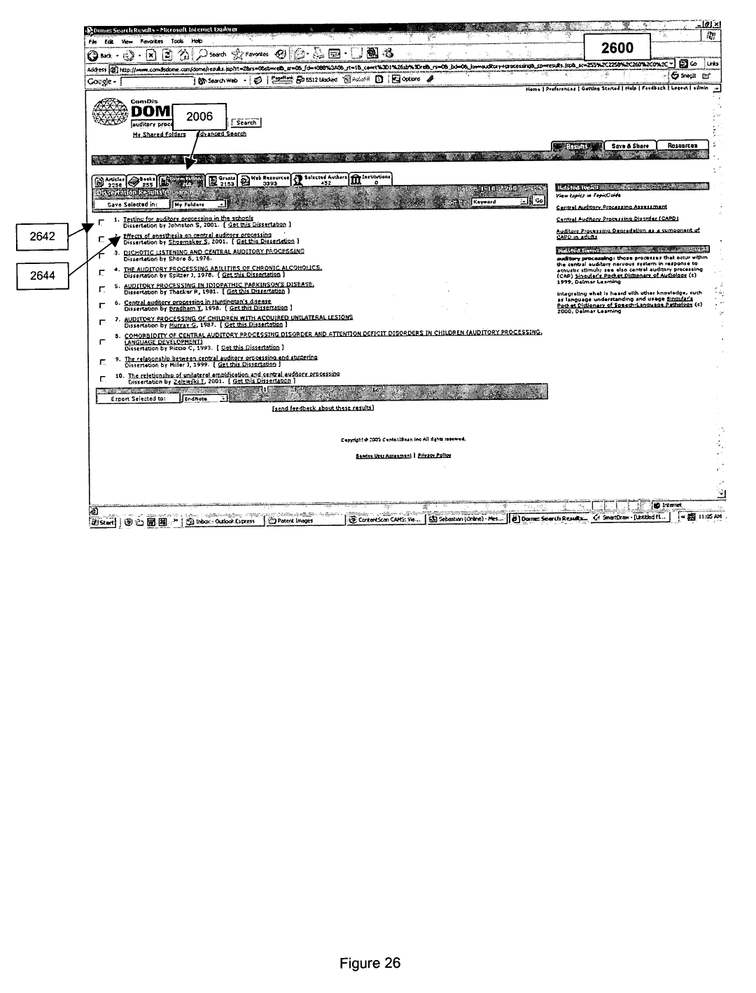

FIG. 26 is an embodiment of a screen shot 2600 of a rank ordered list of dissertations that appear when the dissertations tab 2006 is selected. Each dissertation, for example 2644, is shown as a dynamic link to an expanded view page.

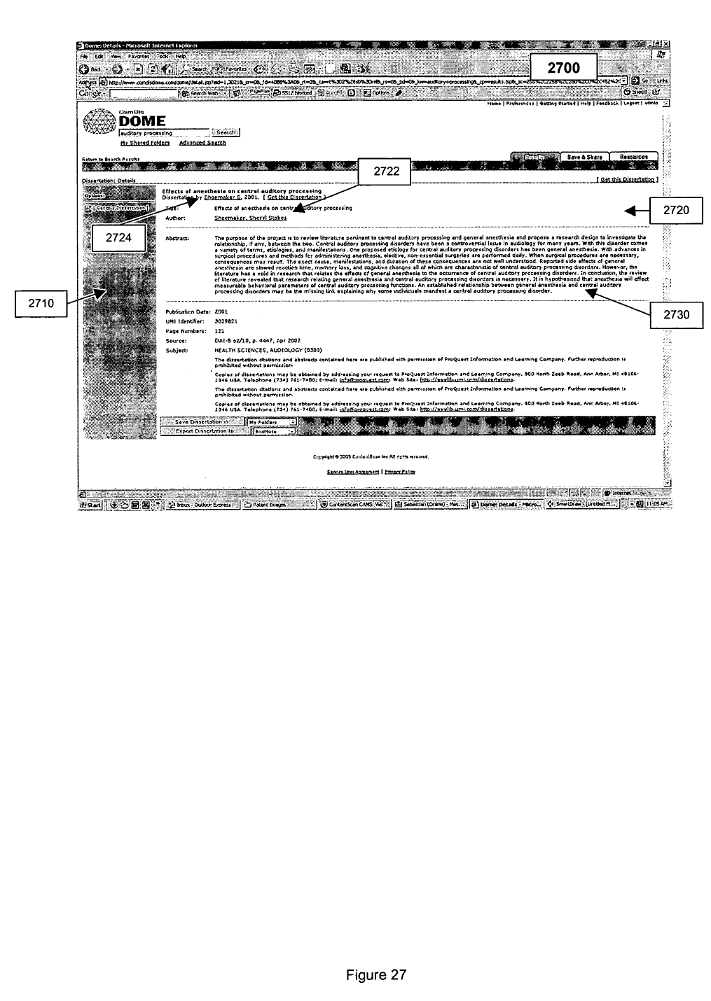

FIG. 27 is an embodiment of a screen shot 2700 of the expanded view of a dissertation 2644 that is selected from the dissertation list of FIG. 26. The expanded listing shows standard bibliographic entries and also includes the abstract 2730. The expanded view also includes one or more dynamic links, for example 2722. Here, the author 2722 is shown as a dynamic link. Selecting the author will transfer the user to a separate page that identifies the expanded view of the author.

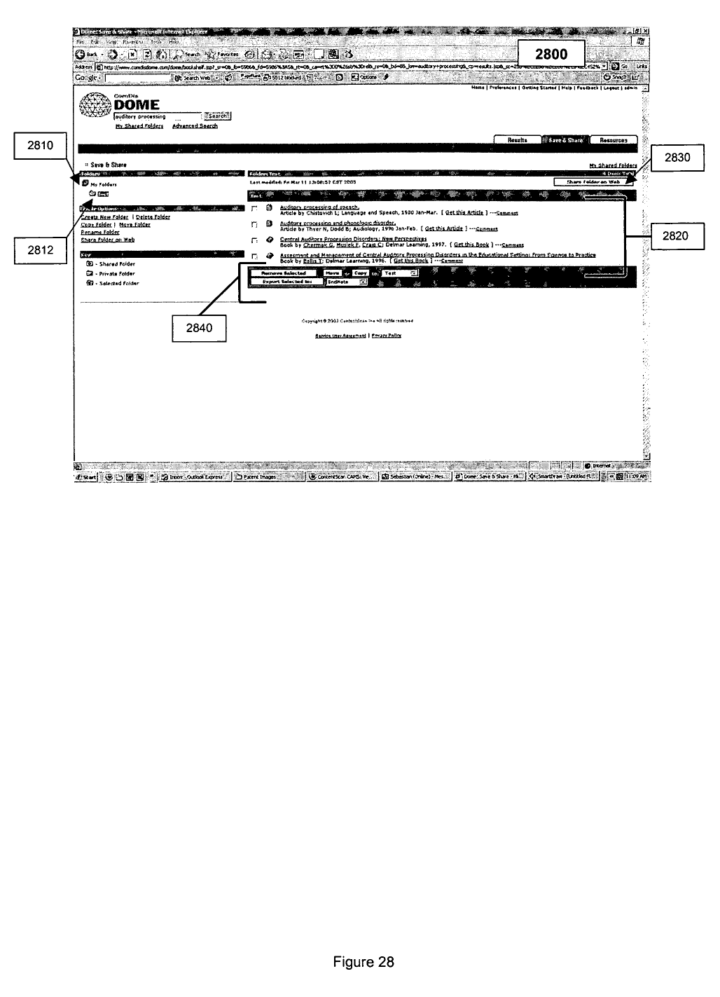

One or more of the search results may be saved in a user-defined folder for future reference. FIG. 28 shows a screen shot 2800 of the contents of a folder 2812 that was generated by selecting results from the rank ordered lists in the search results tab. The user is also provided the opportunity edit the folder 2840 by, for example removing selected items from the folder or exporting items from the folder to another folder or article. Additionally, a share folder item 2830 allows the user to generate a web page to share the search results stored within that folder with those that do not have access to the discipline-specific database.

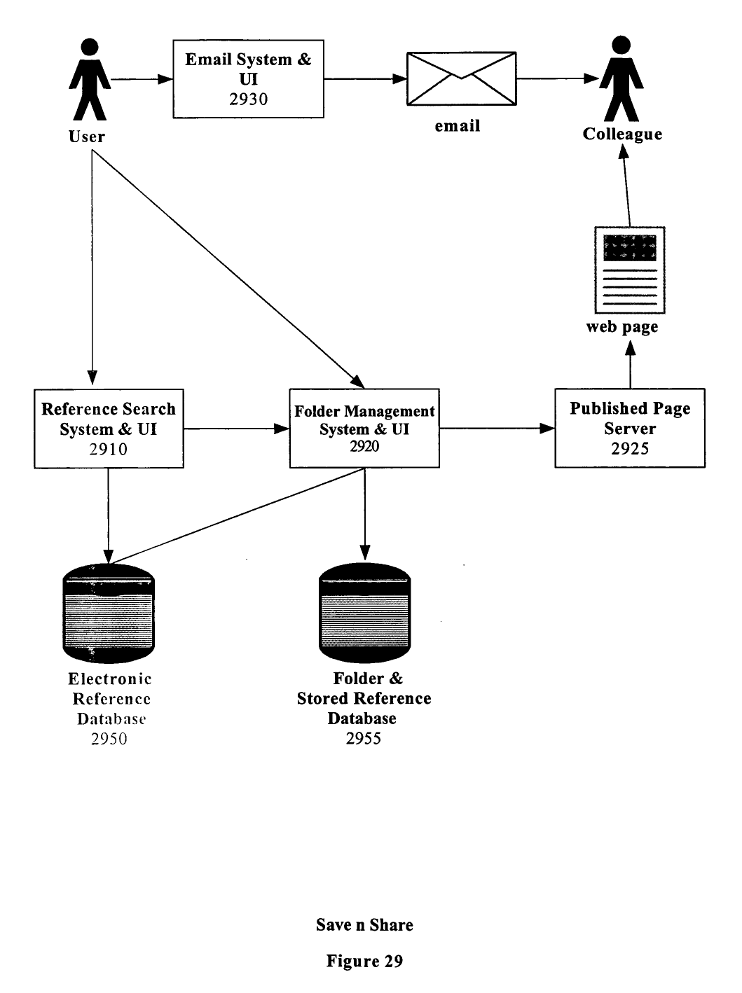

As shown in the user interface screen shot 2800 of FIG. 28, the discipline-specific reference database system allows a user to store selected search results in a user defined folder. The system can also be configured to generate a web page, such as an Internet accessible web page, that can be shared with others that do not have access to the reference database system. FIG. 29 is a functional block diagram of a shared results system based on the discipline-specific database system shown in FIGS. 1 and 18.

The user shown in FIG. 29 is provided as an example of one with access to the discipline-specific reference database system. The colleague in FIG. 29 is shown as one that may or may not have access to the discipline-specific reference database system. The user and colleague represent end users of the save and share system and do not form a part of the save and share system.

The user accesses a reference search system and user interface 2910 to search for information. The reference search system and user interface 2910 can be, for example, the discipline-specific database system shown in FIGS. 1 and 18. For example, the user may access the user interface 1820 provided in the public server 40 of FIG. 18. The user may access the public server 40 via a public client 64 as shown in FIG. 18.

The reference search system and user interface 2910 receives one or more search queries from the user. The reference search system and user interface 2910 can then search an electronic reference database 2950 for information satisfying the queries. For example, in the system of FIG. 18, the public client 64 receives a query and transmits the query across the network 1802 to the user interface 1820 in the public server 40. A search engine 1810 in the public server 40 accesses an electronic database 50 and retrieves one or more entries matching the query. The user interface 1823 then presents the query results to the user. The user can access the query results, for example, using the browser 1850 in the public client 64.

The results can be displayed to the user in one or more linked web pages, as shown in FIGS. 20-27. The search results generated by the reference search system and user interface 2910 can be linked to a folder management system and user interface 2920. The folder management system and user interface 2920 can be, for example, part of the user interface 1820 in the public server 40 of FIG. 18.

The folder management system and user interface 2920 can be configured to allow the user to manage user defined folders. The user defined folders can be stored in a folder and stored reference database 2955. The folder and stored reference database 2955 can be one or more storage modules that are separate and distinct from the electronic reference database 2950. Alternatively, the folder and stored reference database 2955 can share one or more storage modules with the electronic reference database 2950.

As shown in the screen shot of FIG. 28, a user can manage one or more folders within a user folder 2810, labeled in FIG. 28 as ‘My Folders.’ The user can create one or more results folders 2812 within the user folder 2810. As shown in FIG. 28, the user has created a results folder 2812 labeled ‘Test’. The folder management system and user interface 2920 can receive one or more reference selections to add to the results folder, for example 2812.

The folder management system and user interface 2920 can, for example, provide a check box in the various search results pages. A user can select a reference for inclusion into a results folder by highlighting the check box associated with the reference. For example, as shown in the book results screen shot 2000 of FIG. 20, one or more of the book search results is associated with a check box that can be used to select a book. For example, the check box 2042 can be highlighted to indicate that book reference number 1 to be saved in a user folder. Similarly, the author screen shot 2200 of FIG. 22 shows check boxes associated with authors. A user can highlight the check box, for example 2242, to indicate the corresponding author information, for example 2244, is selected for inclusion in the user folder.

The folder management system and user interface 2920 can thus receive one or more reference selections to add to the results folder and can receive a command to add the selected results to the user folder. For example, in the screen shot 2000 of FIG. 20, the user can command the system to save selected references in the user folder by selecting a ‘save’ command button 2040 on the user interface. In response to the user command, the folder management system and user interface 2920 saves the selected data in the folder and stored reference database 2955.

The user can also annotate the stored results. The folder management system and user interface 2920 can receive one or more annotations that are stored in the folder and stored reference database 2955. The annotations can be, for example, associated with selected database results or may be annotations that are independent of any database result.

The user can direct the folder management system and user interface 2920 to generate a web page showing the selected search results contained within a results folder. The folder management system and user interface 2920 receives a command to generate a web page for a specific user folder. As shown in the user interface screen shot of FIG. 28, a user can, for example select a ‘share folder on the web’ 2830 button to command the system to generate a web page. In the embodiment shown in FIG. 28, the button 2830 appears in the same interface page that displays the folder contents. Other embodiments can implement other command input interfaces.

In response to receiving the command to generate the web page, the folder management system and user interface 2920 generates a web page with the information stored within the selected folder. The web page can include dynamic links relating the various stored data items and can include user annotations. The web page can also be stored in the folder and stored reference database 2955 or can be stored in some other storage module (not shown).

The folder management system and user interface 2920 is in communication with a published web page server 2925. The published web page server 2925 can be, for example, an Internet accessible server such as a computer. The published web page server 2925 can access the web pages generated by the folder management system and user interface 2920 and provide access over a network connection. For example, the published web page server 2925 can provide access to, or publish, the web pages at predetermined Internet addresses or URLs.

Once the user has directed the folder management system and user interface 2920 to generate a web page, the user may inform a colleague of the search results. The user can send, for example and e-mail message containing the URL of the web page to the colleague.

An email system and user interface 2930 can receive instructions directing such an email message be generated and sent. For example, the email system and user interface 2930 can allow a user to select one or more user folders stored in the folder and stored reference database 2955. The email system and user interface 2930 can also receive one or more destination e-mail addresses. The email system and user interface 2930 can then generate an email message containing, for example, the URL corresponding to each of the selected user folders. The email system and user interface 2930 can also send the email messages to the desired destination addresses.

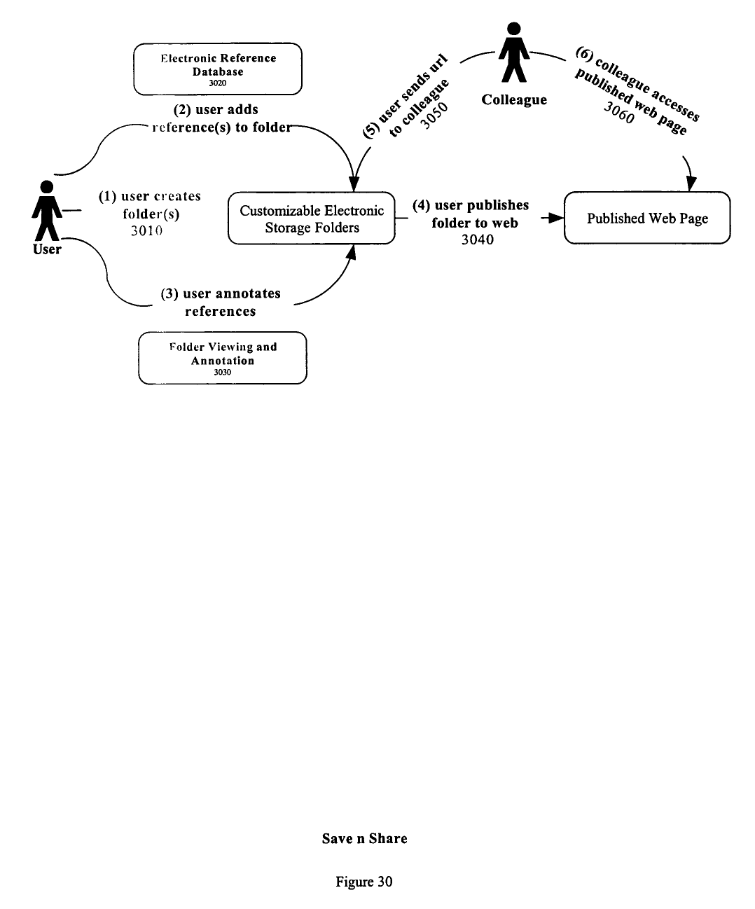

FIG. 30 is a flowchart of a result sharing process that can be performed by the system shown in FIG. 29. Initially, a user accesses a reference database system and creates a user folder 3010. The user folder can be stored as a customizable electronic storage folder. As shown in FIG. 29, the folder management system and user interface can generate a user folder in response to user commands.

The user can then add one or more references 3020 to the user folder. The references can be identified in the same search query or search session or can be identified from different search queries and search sessions. For example, the user can search a discipline specific reference database and identify one or more search results to be added to the user folder. The selected search results can be stored in a selected customizable electronic storage folder.

The user can access the customizable electronic storage folders to view the contents, edit the contents, or annotate the contents 3030. References can be added or removed from the user folder. Additionally, the user can annotate one or more of the items stored in the user folder. Other user annotations may refer generally to the contents of the user folder. For example, general annotations can include identifying one or more search queries used to obtain the results, the dates of the searches, and suggested additional searches.

The user can then publish the contents of a selected user folder 3040. For example, the user can command the reference database system to generate a web page containing the contents of the selected user folder. Alternatively, a spreadsheet, email message, text document, and the like, or some other publication format can be used.

Once the user publishes the contents of the folder, the user can inform one or more colleagues of the availability of the data. For example, the user can send to a colleague a URL corresponding to a web page containing the search results. The user can send, for example, an email message to the colleague containing the URL. Alternatively, the user can generate and send a phone message, paging message, text message, or some other message identifying the location of the published results.

Thus, one or more embodiments of a searchable, navigatable, or publishable database that produces results that can allow for discipline-specific searching which can be transparent to a type of reference source and can allow for navigation to, from, or between database elements and methods for creating the same are disclosed. The various database system and method embodiments can be based on one or more logical data models that can be implemented using one or more modules. The modules can import, parse, and link various discipline-specific data to allow a researcher to perform a focused search of data that is relevant to one or more disciplines or fields of discourse.

The various modules and processes detailed in the figures and descriptions can be modified to omit certain functions and include other functions in other embodiments. Additionally, the various modules and processes need not necessarily be performed in the order shown or discussed, and the order may typically be modified unless order is logically required. For example, normalization logically occurs after import of data. However, the order in which data is imported or the order in which imported data is normalized can be modified as a matter of design.

Couplings and connections have been described with respect to various devices, modules, or elements. The connections and couplings can be direct or indirect. A connection between a first and second module can be a direct connection or can be an indirect connection. An indirect connection can include interposed elements that can process the signals from the first device to the second device.

Those of skill will further appreciate that the various illustrative logical blocks, modules, circuits, and algorithm steps described in connection with the embodiments disclosed herein can be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the present invention.

The steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such the processor can read information from, and write information to, the storage medium. In the alternative, the storage medium can be integral to the processor. The processor and the storage medium can reside in an ASIC.

The above description of the disclosed embodiments is provided to enable any person skilled in the art to make or use the invention. Various modifications to these embodiments will be readily apparent to those skilled in the art, and the generic principles defined herein can be applied to other embodiments without departing from the spirit or scope of the invention. Thus, the invention is not intended to be limited to the embodiments shown herein but is to be accorded the widest scope consistent with the principles and novel features disclosed herein.

1. A database creation system for representing natural form entities, the system comprising:
an import module configured to receive input electronic data relating to natural form entities and to convert the electronic data into surface form entities wherein each surface form entity represents one natural form entity and wherein one natural form entity can have more than one corresponding surface form entity; and
a normalization module configured to receive surface form entities and convert them to definitive form entities when the information contained within the surface form meets selected criteria, wherein each definitive form entity corresponds to a single natural form entity and there is only one definitive form entity for any one natural form entity and wherein definitive form entities include information regarding relationships to other definitive form entities.

2. The system of claim 1, wherein the normalization module is further configured to merge multiple surface form entities that represent the same natural form entity into a single definitive form entity.

3. The system of claim 2, further comprising a publication module configured to receive definitive form entities from said normalization module and to form an index.

4. The system of claim 3, wherein said publication module is further configured to remove selected portions of data from said definitive form entities.

5. A method of creating a database for representing natural form entities, the method comprising:
receiving electronic data relating to natural form entities;
converting the electronic data into surface form entities, each surface form entity having attributes that characterize the natural form entity which the surface entity represents, wherein each surface form entity represents one natural form entity and wherein one natural form entity can have more than one corresponding surface form entity; and
converting a surface form entity to a definitive form entity when the attributes of the surface form entity meet selected criteria, wherein each definitive form entity corresponds to a single natural form entity and there is only one definitive form entity for any one natural form entity.

6. The method of claim 5 further comprising merging multiple surface form entities that represent the same natural form entity into a single definitive form entity.

7. The method of claim 6, further comprising creating an index from the attributes of the definitive form entities.

8. The method of claim 7 further comprising removing selected portions of data from said definitive form entities.

9. The method of claim 7, wherein definitive form entities include information regarding relationships to other definitive form entities

10. The method of claim 9, wherein natural form entities include persons and publications.

11. The method of claim 10 wherein creating the index includes associating person definitive form entities with key words from publication definitive form entities related to the person definitive form entities.

12. The method of claim 5 further comprising associating meta data with selected attributes of surface form entities, wherein the meta data includes information about the associated attribute.

13. The method of claim 12 wherein the meta data includes information selected from the start and end date of the associated attribute, the date of occurrence of the associated attribute, the source of the evidence of the existence of the associated attribute and the believability of that source.

14. A database creation system for representing natural form entities comprising:
an import module configured to receive input electronic data relating to publications and persons and to convert the electronic data into surface form entities wherein each surface form entity represents one person or publication and represents association between person surface form entities and publication surface form entities and wherein one person or publication can have more than one corresponding surface form entity;
a normalization module configured to receive surface form entities and convert them to definitive form entities when the information contained within the surface form meets selected criteria, wherein each definitive form entity corresponds to a person or publication and there is only one definitive form entity for any one person or publication; and
a publication module configured to create an index from the definitive form entities wherein each person definitive form entity has an associated collection of publication definitive form entities such that searching can be performed upon the publication definitive form entities associated with a person definitive form entity.

15. A method of creating a database for representing natural form entities, the method comprising:
receiving electronic data relating to publications and persons;
converting the electronic data into surface form entities in the database, wherein each surface form entity represents one person or one publication, each surface form entity includes attributes that characterize the natural form entity which the surface entity represents, with one attribute being the relationship of authorship between a person and a publication, and one person or publication can have more than one corresponding surface form entity;
converting surface form entities to definitive form entities when the attributes of the surface form meets selected criteria, wherein each definitive form entity corresponds to a person or publication and there is only one definitive form entity for any one person or publication; and
creating an index from the definitive form entities wherein each person definitive form entity has an associated collection of publication definitive form entities such that searching can be performed upon the publication definitive form entities associated with a person definitive form entity.
